(19) United States
(12) Patent Application Publication
(10) Pub. No.: US 2003/0142093 A1
(43) Pub. Date: Jul. 31, 2003

(54) Three-dimensional non-linear numerical ordering system

(75) Inventor: Victor Manuel Barrios Llanos, Zaragoza (ES)

Correspondence Address: NOTARO AND MICHALOS, 100 DUTCH HILL ROAD, SUITE 110, ORANGEBURG, NY, 10962-2100, US

(73) Assignee: Espacio T., S.L.

(21) Appl. No.: 10/326,255

(22) Filed: Dec. 19, 2002

Related U.S. Application Data
(63) Continuation of application No. PCT/ES01/00259, filed on Jun. 29, 2001.

(30) Foreign Application Priority Data
Jun. 30, 2000 (ES) P 200001626

(51) Int. Cl. G06T 15/00

(52) U.S. Cl. 345/419

(57) ABSTRACT

The invention relates to a three-dimensional non-linear numerical ordering system, consisting of a discrete structure, preferably three-dimensional in the form of a cube, wherein it is possible to operate with the 512⁸ sub-units or information points in simultaneous mode by means of symmetry operations following the same constant cycle in each of the three coordinates (x, y, z) that define it, and with the aid of a fourth coordinate w, thereby resulting in a computationally irreducible system based on an isotropic unit pattern structure with fractal characteristics and properties. This invention can be applied to computing components for information handling.

### FIELD AND BACKGROUND OF THE INVENTION

The present invention relates generally to the field of digital information processing and in particular, to a three-dimensional non-linear numerical ordering system, developed to be integrated in computer components for information processing purposes.

The current digital information processing systems are mainly based on the use of binary codes or sequential references, represented in octal, hexadecimal, or other notations. With these systems, the higher the number of addresses the information is to be referenced in, the higher the number of digits needed to achieve it.

From the technical point of view, the problem is that when the volume of information to be processed is very high (because of its content or characteristics), the number of digits required to define the location and characteristics of the information also rises, reducing the efficiency of the information management processes, so much so that there comes a point where it is difficult to operate on it with the minimum desired efficiency.

When the transmission time of digital information is virtually instant, or when the volume of simultaneous information is very high, the linear or sequential processing of the information limits the potential of the system. This difficulty gets worse when operating with multimedia information (video, audio, text, etc.) in real time. The flexibility and tolerance of the system is limited by the organizational standard used by the current digital information management systems.

The organization pattern determines the characteristics of the whole system.

Current computers use binary logic for information processing and storing. We will call this type of computer “classic computer.” Binary logic is characterized by the use of only two independent statuses in order to form its operations base. These two statuses are usually represented by one and 0, and they support the basic unit of information, called “bit.” This information bit can be physically supported in several ways.

Nowadays, information is stored in optical or magnetic discs, where up to thousands of millions of bits can be stored in the same space that an old one used to take. In optical discs, a bit is recorded in a minute space of the disc's substratum. Endless successions of perforations and spaces can be read by the scanner's laser beam. Nowadays an “optical” bit can take up just a few angstroms, as the media surfaces can be handled at microscopic scale.

Overall, the limits of binary computing system development depend on the costs in terms of time, the costs of information recovery, and the miniaturization of circuits, which seems to be reaching its technical limit, amongst other reasons due to the heat resistance capacity of the integrated circuits. The use of new media, compatible with the current ones, is based on the knowledge and/or modeling of the route or behavior of the energy flows in the CPU, and on the fact that such behavior can be represented and made operational with the minimum possible number of digits and/or operations. This requires a new ordering system, and here is where this new invention brings an answer.

### SUMMARY OF THE INVENTION

Many materials and structures that are useful for technology already have regular patterns; whose advantages are currently well known, for example in the petrochemical sector. The natural minerals called zeolites have atomic size frames in which the aluminum, silicon, and oxygen atoms organize themselves in scaffoldings linked by tunnels and dotted with cavities. These natural patterns are reproduced in the laboratory and used to increase the octane level of oil.

The three-dimensional non-linear numerical ordering system extends and improves the current usefulness of digital information management systems, as it generates a new way of creating references within the information volume and between the information and the user; this constant way of ordering information is an inherent part of the new management system, as it establishes a new organization and access pattern in the electronic communication processes that characterize the ordering system. In addition, the ordering system is provided with the required standard interfaces to receive and operate on digital information in current electronic systems.

The three-dimensional non-linear (non-consecutive) numerical ordering system that is the subject of the present invention has been developed as a solution to the existing problems related to the actual information searching, processing, transferring, and storing times. This device can be applied to multiple areas in computing.

The three-dimensional non-linear (non-consecutive) numerical ordering system consists of a discrete device or structure for processing digital information through the application of a complex system made up of a series of simple interacting components, which we will call sub-units or cells, able to exchange information with their environment.

It is based on a discrete structure, preferably three-dimensional, where the sub-units or cells represented in such a structure are ordered non-linearly, in the sense of non-consecutive elements, through some symmetry operations, in such a way that, integrated in a standard information management system, makes it possible to operate with 512⁸ information points.

The initial structure is a preferably cubic structure where each of its three axes is divided into eight equal segments numbered, for example, from 0 to 7 in octal (base 8) notation from the origin of coordinates. Consequently, the initial structure is divided into 512 equal sub-units (cells), identified by three digits, each of which being the coordinate segment that represents its location in relation to the Z, Y, X axes that define the structure. Digits 000 will thus identify the subunit or cell that represents the origin of coordinates; digits 100, 010, 001 will identify the adjacent sub-units in the three axes and so on until the 8³ sub-units are completed. The last subunit (number 512) will be defined, always following in octal (base 8) notation, by the digits 777. Based on that ordering, we carry out certain symmetry transformations in order to establish a non-linear ordering (non-consecutive) within the structure characterized in that it presents the same constant patterns and patterns sequences in the three coordinates.

We also define a fourth coordinate, with a behavior similar to the three coordinates defining the unit patter structure. We can manage the whole volume of information contained and/or represented, in the system using the minimum possible number of digits and the minimum possible number of algorithmical operations using the three-dimensional non-linear numerical ordering system, as the structure has the same behavior for any coordinate.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 shows the initial basic structure (1) with its origin of coordinates (5), as well as the divisions and values assigned to them;

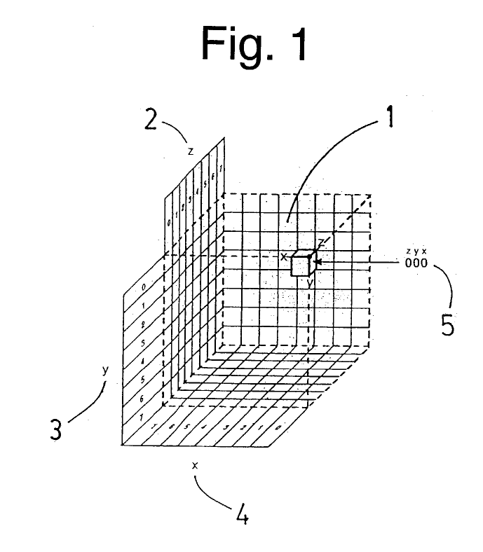

FIG. 2 shows the initial basic structure (1) divided into 512 sub-units or cells;

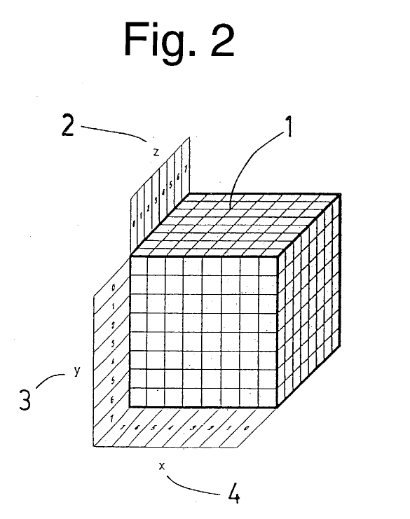

FIG. 3 shows the initial basic structure with the initial origin of coordinates' subunit (5) and its adjacent sub-units -100-(6), -010-(7), -001-(8), -777-(9), as well as the location of the last subunit;

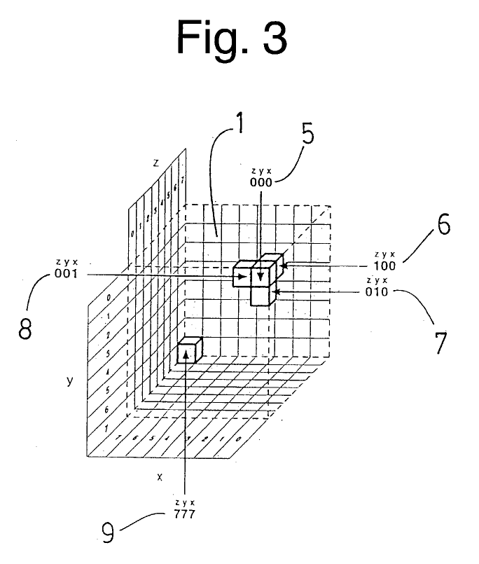

FIG. 4 shows the initial basic structure (1) with the first layer values corresponding to coordinate -Z- (2); z-0 (10);

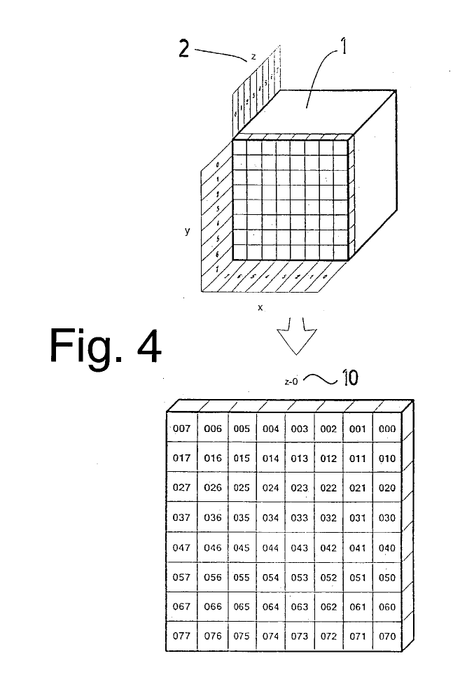

FIG. 5 shows the initial basic structure (1) with the second layer values corresponding to coordinate -Z- (2); z-1 (11);

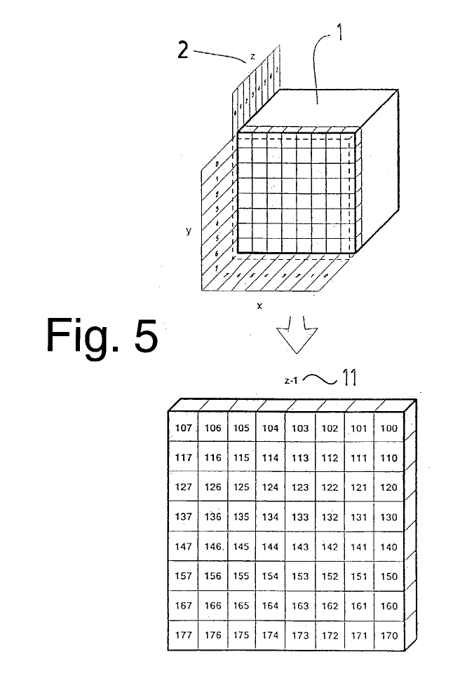

FIG. 6 shows the initial basic structure (1) with the third layer values corresponding to coordinate -Z- (2); z-2 (12);

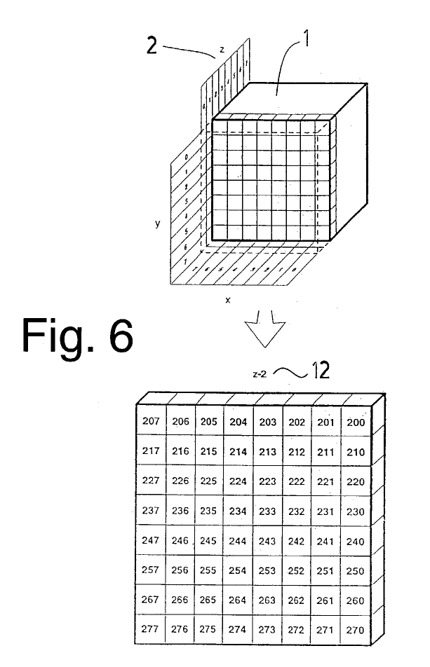

FIG. 7 shows the initial basic structure (1) with the fourth layer values corresponding to coordinate -Z- (2); z-3 (13).

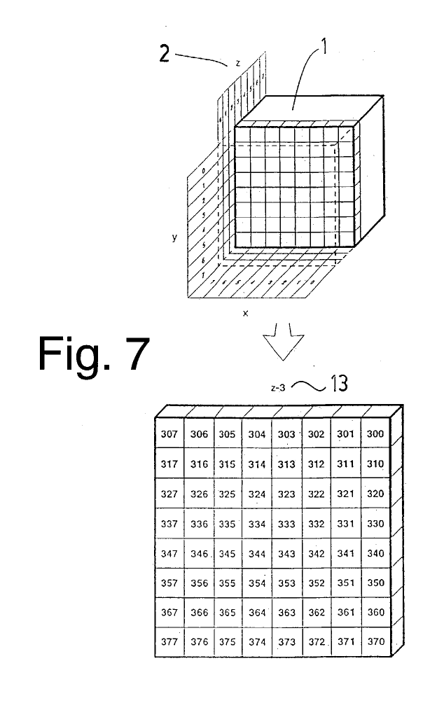

FIG. 8 shows the initial basic structure (1) with the fifth layer values corresponding to coordinate -Z- (2); z-4 (14);

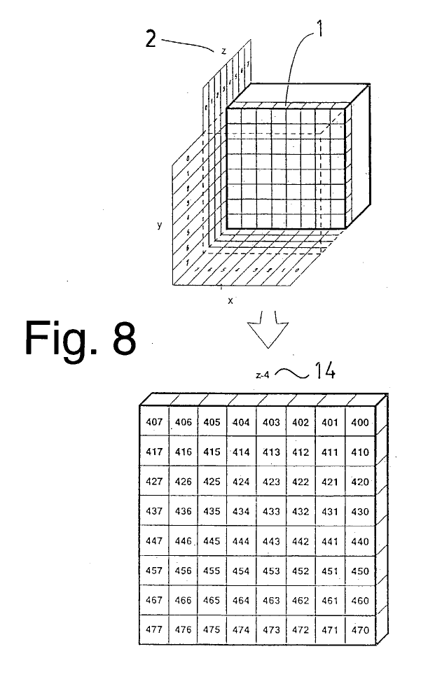

FIG. 9 shows the initial basic structure (1) with the sixth layer values corresponding to coordinate -Z- (2); z-5 (15);

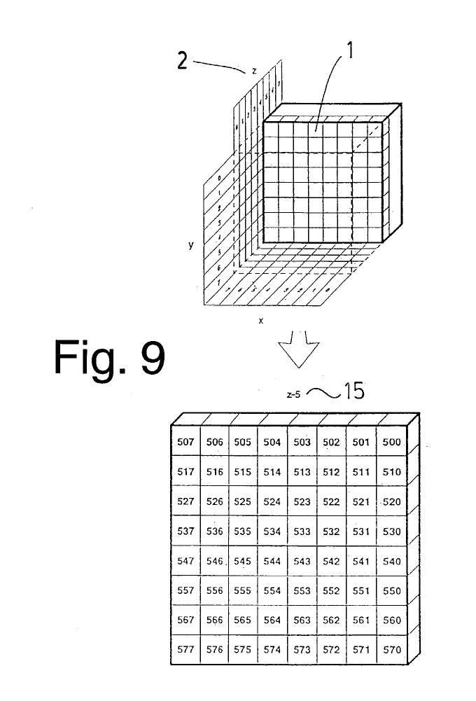

FIG. 10 shows the initial basic structure (1) with the seventh layer values corresponding to coordinate -Z- (2) z-6 (16);

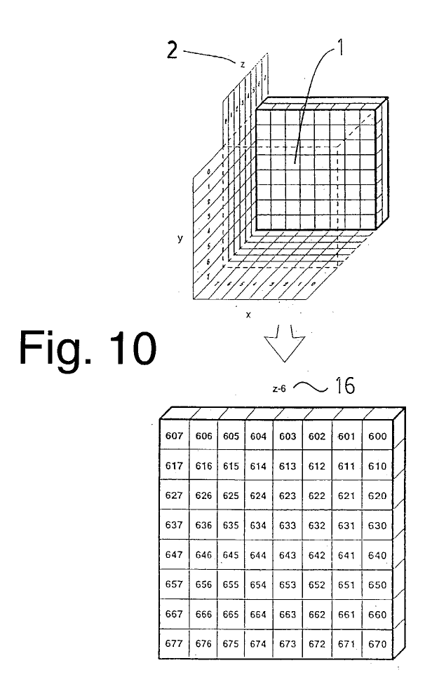

FIG. 11 shows the initial basic structure (1) with the eighth layer values corresponding to coordinate -Z- (2) z-7 (17);

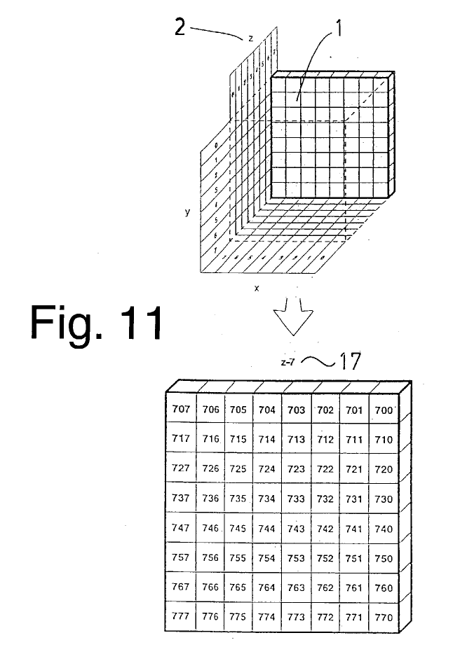

FIG. 12 shows the initial basic structure with the value of the sub-units or cells located at each vertex;

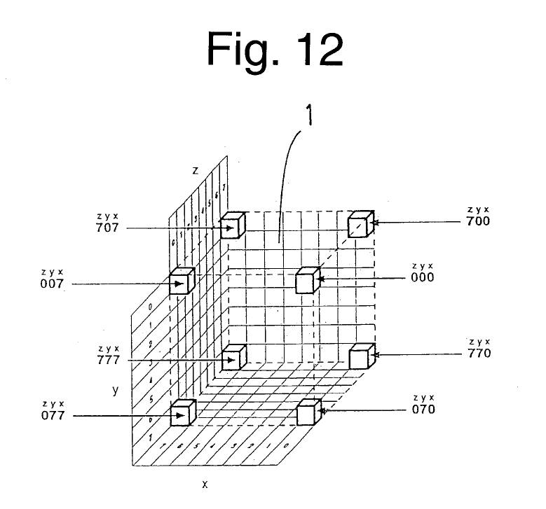

FIG. 13 shows the partial result obtained by applying the reflection on the orthogonal middle plane of the X direction (4) for the sub-units of the first Z_{X}-0 (21) layer. Varying sub-units or cells appear highlighted in bold (larger). Sub-units or cells where the symmetry operation is not applied appear in italics (smaller). The symmetry plane will be designated as Π_{X} (18);

FIG. 14 shows the partial result obtained by applying the reflection on the orthogonal middle plane of the X direction (4) for the sub-units of the second Z_{X}-1 (22) layer. Varying sub-units appear highlighted in bold (larger). Sub-units where the symmetry operation is not applied appear in italics (smaller). The symmetry plane will be designated as Π_{X} (18);

FIG. 15 shows the partial result obtained by applying the reflection on the orthogonal middle plane of the X direction (4) for the sub-units of the third Z_{X}-2 (23) layer. Varying sub-units appear highlighted in bold (larger). Sub-units where the symmetry operation is not applied appear in italics (smaller). The symmetry plane will be designated as Π_{X} (18);

FIG. 16 shows the partial result obtained by applying the reflection on the orthogonal middle plane of the X direction (4) for the sub-units of the fourth Z_{X}-3 (24) layer. Varying sub-units appear highlighted in bold (larger). Sub-units where the symmetry operation is not applied appear in italics (smaller). The symmetry plane will be designated as Π_{X} (18);

FIG. 17 shows the partial result obtained by applying the reflection on the orthogonal middle plane of the X direction (4) for the sub-units of the fifth Z_{X}-4 (25) layer. Varying sub-units appear highlighted in bold (larger). Sub-units where the symmetry operation is not applied appear in italics (smaller). The symmetry plane will be designated as Π_{X} (18);

FIG. 18 shows the partial result obtained by applying the reflection on the orthogonal middle plane of the X direction (4) for the sub-units of the sixth Z_{X}-5 (26) layer. Varying sub-units appear highlighted in bold (larger). Sub-units where the symmetry operation is not applied appear in italics (smaller). The symmetry plane will be designated as Π_{X} (18);

FIG. 19 shows the partial result obtained by applying the reflection on the orthogonal middle plane of the X direction (4) for the sub-units of the seventh Z_{X}-6 (27) layer. Varying sub-units appear highlighted in bold (larger). Sub-units where the symmetry operation is not applied appear in italics (smaller). The symmetry plane will be designated as Π_{X} (18);

FIG. 20 shows the partial result obtained by applying the reflection on the orthogonal middle plane of the X direction (4) for the sub-units of the eighth Z_{X}-7 (28) layer. Varying sub-units appear highlighted in bold (larger). Sub-units where the symmetry operation is not applied appear in italics (smaller). The symmetry plane will be designated as Π_{X} (18);

FIG. 21 shows the partial result obtained by applying the reflection on the orthogonal middle plane of the Y direction (3) for the sub-units of the first Z_{Y}-0 (30) layer. Varying sub-units appear highlighted in bold (larger). Sub-units where the symmetry operation is not applied appear in italics (smaller). The symmetry plane will be designated as Π_{Y} (29);

FIG. 22 shows the partial result obtained by applying the reflection on the orthogonal middle plane of the Y direction (3) for the sub-units of the second Z_{Y}-1 (31) layer. Varying sub-units appear highlighted in bold (larger). Sub-units where the symmetry operation is not applied appear in italics (smaller). The symmetry plane will be designated as Π_{Y} (29);

FIG. 23 shows the partial result obtained by applying the reflection on the orthogonal middle plane of the Y direction (3) for the sub-units of the third Z_{Y}-2 (32) layer. Varying sub-units appear highlighted in bold (larger). Sub-units where the symmetry operation is not applied appear in italics (smaller). The symmetry plane will be designated as Π_{Y} (29);

FIG. 24 shows the partial result obtained by applying the reflection on the orthogonal middle plane of the Y direction (3) for the sub-units of the fourth Z_{Y}-3 (33) layer. Varying sub-units appear highlighted in bold (larger). Sub-units where the symmetry operation is not applied appear in italics (smaller). The symmetry plane will be designated as Π_{Y} (29);

FIG. 25 shows the partial result obtained by applying the reflection on the orthogonal middle plane of the Y direction (3) for the sub-units of the fifth Z_{Y}-4 (34) layer. Varying sub-units appear highlighted in bold (larger). Sub-units where the symmetry operation is not applied appear in italics (smaller). The symmetry plane will be designated as Π_{Y} (29);

FIG. 26 shows the partial result obtained by applying the reflection on the orthogonal middle plane of the Y direction (3) for the sub-units of the sixth Z_{Y}-5 (35) layer. Varying sub-units appear highlighted in bold (larger). Sub-units where the symmetry operation is not applied appear in italics (smaller). The symmetry plane will be designated as Π_{Y} (29);

FIG. 27 shows the partial result obtained by applying the reflection on the orthogonal middle plane of the Y direction (3) for the sub-units of the seventh Z_{Y}-6 (36) layer. Varying sub-units appear highlighted in bold (larger). Sub-units where the symmetry operation is not applied appear in italics (smaller). The symmetry plane will be designated as Π_{Y} (29);

FIG. 28 shows the partial result obtained by applying the reflection on the orthogonal middle plane of the Y direction (3) for the sub-units of the eighth Z_{Y}-7 (37) layer. Varying sub-units appear highlighted in bold (larger). Sub-units where the symmetry operation is not applied appear in italics (smaller). The symmetry plane will be designated as Π_{Y} (29);

FIG. 29 shows the partial result obtained by applying the reflection on the orthogonal middle plane of the Z direction (2) for the sub-units of the first Z_{Z}-0 (39) layer. Varying sub-units appear highlighted in bold (larger). Sub-units where the symmetry operation is not applied appear in italics (smaller). The symmetry plane will be designated as Π_{Z} (38);

FIG. 30 shows the partial result obtained by applying the reflection on the orthogonal middle plane of the Z direction (2) for the sub-units of the second Z_{Z}-1 (40) layer. Varying sub-units appear highlighted in bold (larger). Sub-units where the symmetry operation is not applied appear in italics (smaller). The symmetry plane will be designated as Π_{Z} (38);

FIG. 31 shows the partial result obtained by applying the reflection on the orthogonal middle plane of the Z direction (2) for the sub-units of the third Z_{Z}-2 (41) layer. Varying sub-units appear highlighted in bold (larger). Sub-units where the symmetry operation is not applied appear in italics (smaller). The symmetry plane will be designated as Π_{Z} (38);

FIG. 32 shows the partial result obtained by applying the reflection on the orthogonal middle plane of the Z direction (2) for the sub-units of the fourth Z_{Z}-3 (42) layer. Varying sub-units appear highlighted in bold (larger). Sub-units where the symmetry operation is not applied appear in italics (smaller). The symmetry plane will be designated as Π_{Z} (38);

FIG. 33 shows the partial result obtained by applying the reflection on the orthogonal middle plane of the Z direction (2) for the sub-units of the fifth Z_{Z}-4 (43) layer. Varying sub-units appear highlighted in bold (larger). Sub-units where the symmetry operation is not applied appear in italics (smaller). The symmetry plane will be designated as Π_{Z} (38);

FIG. 34 shows the partial result obtained by applying the reflection on the orthogonal middle plane of the Z direction (2) for the sub-units of the sixth Z_{Z}-5 (44) layer. Varying sub-units appear highlighted in bold (larger). Sub-units where the symmetry operation is not applied appear in italics (smaller). The symmetry plane will be designated as Π_{Z} (38);

FIG. 35 shows the partial result obtained by applying the reflection on the orthogonal middle plane of the Z direction (2) for the sub-units of the seventh Z_{Z}-6 (45) layer. Varying sub-units appear highlighted in bold (larger). Sub-units where the symmetry operation is not applied appear in italics (smaller). The symmetry plane will be designated as Π_{Z} (38);

FIG. 36 shows the partial result obtained by applying the reflection on the orthogonal middle plane of the Z direction (2) for the sub-units of the eighth Z_{Z}-7 (46) layer. Varying sub-units appear highlighted in bold (larger). Sub-units where the symmetry operation is not applied appear in italics (smaller). The symmetry plane will be designated as Π_{Z} (38);

FIG. 37 shows the result, over the vertex of the cube, of the reflection on the -X- coordinate symmetry plane Π_{X} (18);

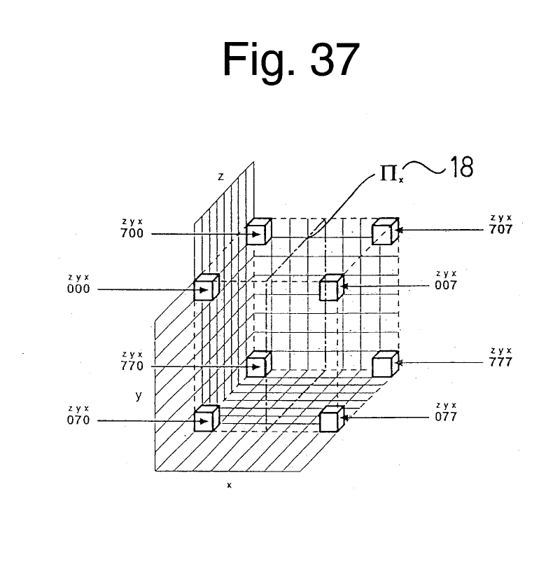

FIG. 38 shows the result of Π_{XY} (47) composing, made of two consecutive reflections; first one on X coordinate's symmetry plane, Π_{X} (18), and second one on Y coordinate's symmetry plane, Π_{Y} (29), both on cube's vertex;

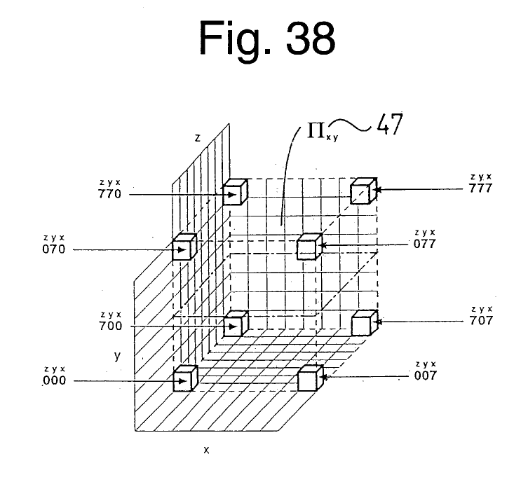

FIG. 39 shows the result of composing three consecutive reflections Π_{XYZ} (48); first one on X coordinate's symmetry plane, Π_{X} (18), second one on Y coordinate's symmetry plane, Π_{Y} (29), and third on Z coordinate's symmetry plane, Π_{Z} (38), all of them on cube's vertex;

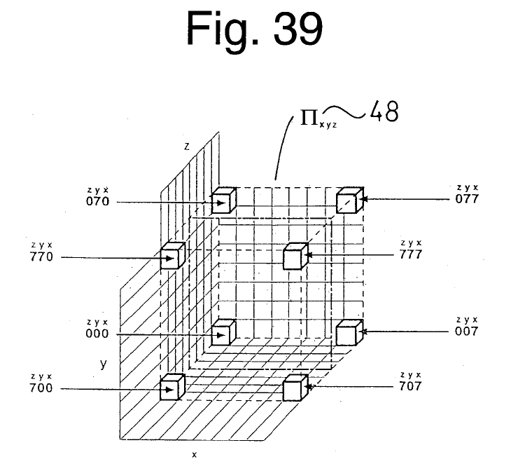

FIG. 40 presents an scheme of the variation-stay patterns associated with the composition of the three consecutive orthogonal reflections, Π_{XYZ} (48), on X(4), Y(3), and Z(2) axes. Sub-units in black represent those where all this operations where successfully carried out, while the sub-units that stayed in the same position appear in white. As you can see in the figure, in layers: Z_{M}-0, Z_{M}-3, Z_{M}-4, and Z_{M}-7 (49) the subunits they have effect on are placed on equivalent positions on all four layers, and the same happens for the following layers: Z_{M}-1, Z_{M}-2, Z_{M}-5, and Z_{M}-6 (49);

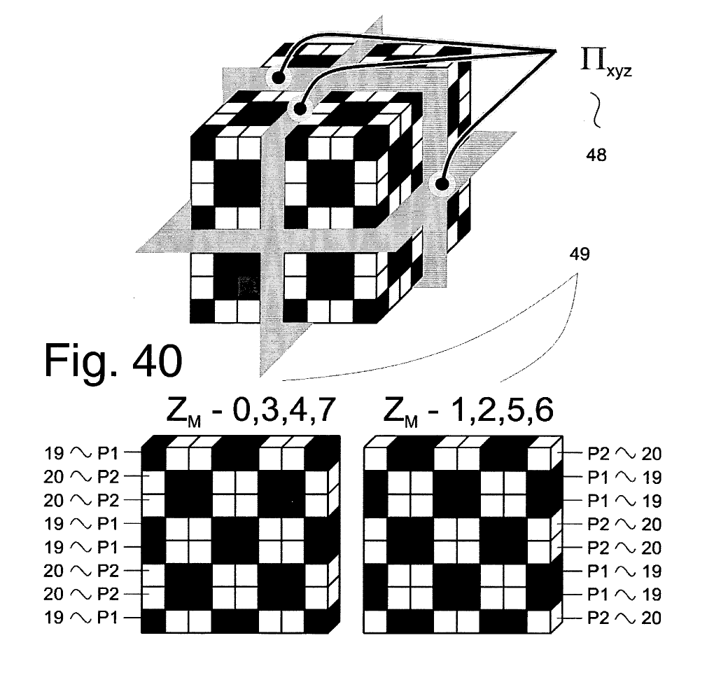

FIG. 41 shows the result of composing three consecutive reflections; first one on X coordinate's symmetry plane, Π_{X} (18) plane, second one on Y coordinate's symmetry plane, Π_{Y} (29) plane, and third on Z coordinate's symmetry plane Π_{Z} (38), on first Z_{M}-0 (50) layer's sub-units, in the unit pattern structure (49);

FIG. 42 shows the values established in the unit pattern structure (49) corresponding to coordinate -z-, second layer; Z_{M}-1 (51);

FIG. 43 shows the values established in the unit pattern structure (49) corresponding to coordinate -z-, third layer; Z_{M}-2 (52);

FIG. 44 shows the values established in the unit pattern structure (49) corresponding to coordinate -z-, fourth layer; Z_{M}-3 (53);

FIG. 45 shows the values established in the unit pattern structure (49) corresponding to coordinate -z-, fifth layer; Z_{M}-4 (54);

FIG. 46 shows the values established in the unit pattern structure (49) corresponding to coordinate -z-, sixth layer; Z_{M}-5 (55);

FIG. 47 shows the values established in the unit pattern structure (49) corresponding to coordinate -z-, seventh layer; Z_{M}-6 (56);

FIG. 48 shows the values established in the unit pattern structure (49) corresponding to coordinate -z-, eighth layer; Z_{M}-7 (57);

FIG. 49 shows schematically the fourth coordinate, W (58);

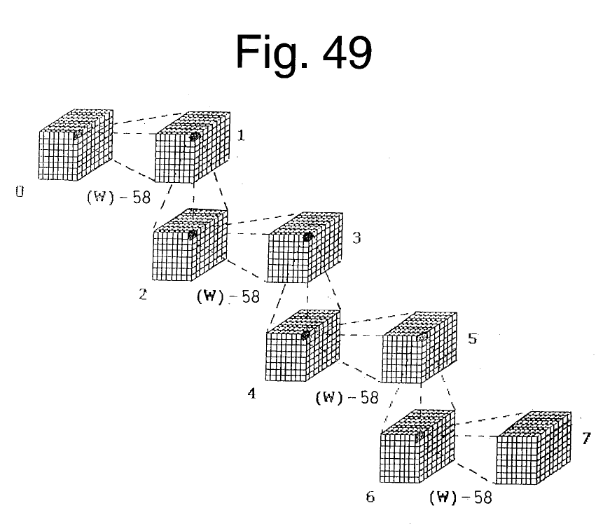

FIG. 50 schematically shows the first stage of the path that must be followed to convey with the original ordering (1), after the non-linear ordering (non-consecutive) is established in the structure (49);

FIG. 51 schematically shows the second stage where starting at the end position of 000-Z_{M}-7 layer, (57), we will reach position 001 (permanent) on Z_{M}-0 layer, (50);

FIG. 52 schematically shows the third stage where we reach position 002 (permanent) on that same layer;

FIG. 53 schematically shows the fourth stage continuing with end position 003 (that has changed) on Z_{M}-7 layer, (57);

FIG. 54 schematically shows the fifth stage where next, we go to 004 end position (that has changed too), on the same layer;

FIG. 55 schematically shows the sixth stage where next, we will jump to position 005 (permanent) on Z_{M}-0 layer;

FIG. 56 schematically shows the seventh stage, jumping to position 006 (permanent) on the same layer (57);

FIG. 57 schematically shows the eight stage where the graph ends in final position, 007.

### DESCRIPTION OF THE PREFERRED EMBODIMENTS

The three-dimensional non-linear numerical ordering system being put forward consists of, as can be seen in the figures mentioned above, a digital information processing device that uses a complex system made up of simple interacting components, the sub-units or cells, that are able to exchange information with their environment.

It is based on a discrete structure, preferably three-dimensional, where a non-linear (non-consecutive) ordering (49) has been established, through some symmetry operations that we are going to describe later, in such a way that, integrated in a standard information management system, makes it possible to operate with 512⁸ information points.

In order to establish the three-dimensional non-linear numerical ordering system (49), the initial structure is a cubic system (1) where each of its three axes is divided into eight segments, for example 0 to 7 in base 8, from the origin of coordinates. Consequently, the initial structure is divided into 512 equal sub-units, identified by three digits, each one of them being the segment of the coordinate that represents its location in relation to the Z (2), Y (3), X (4) axes respectively. The subunit that represents the origin point of coordinates will be identified by the digits 000 (5), and the adjacent sub-units at each of the three axes will be 100 (6), 010 (7), 001 (8), and so on until the 8³ sub-units are completed. The last subunit, number 512, will be defined, always following in base 8, by the digits 777 (9) and will be located at the end opposite to the first one, identified by the digits 000 (5), as it can be seen in the first figures.

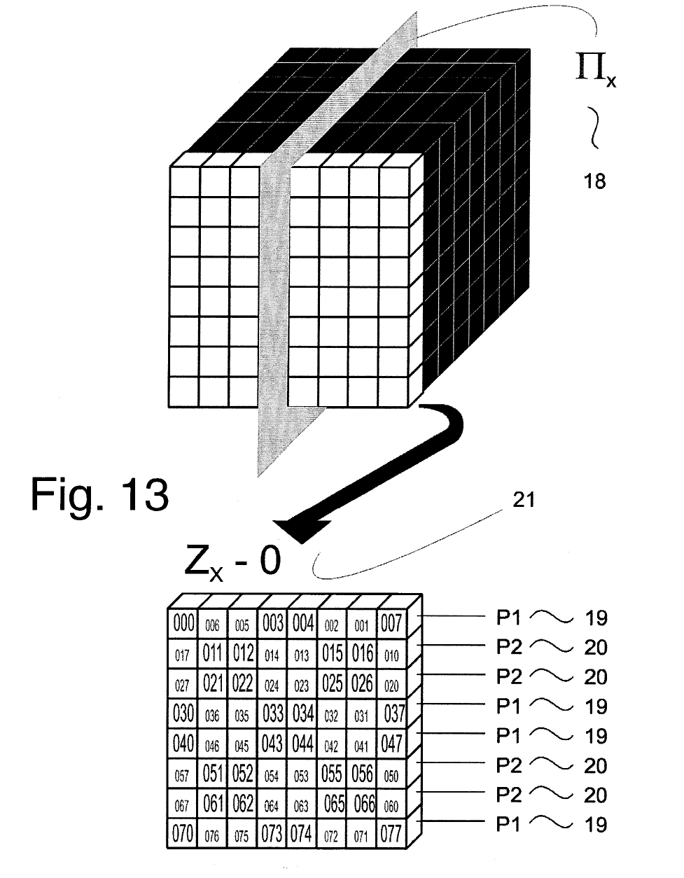

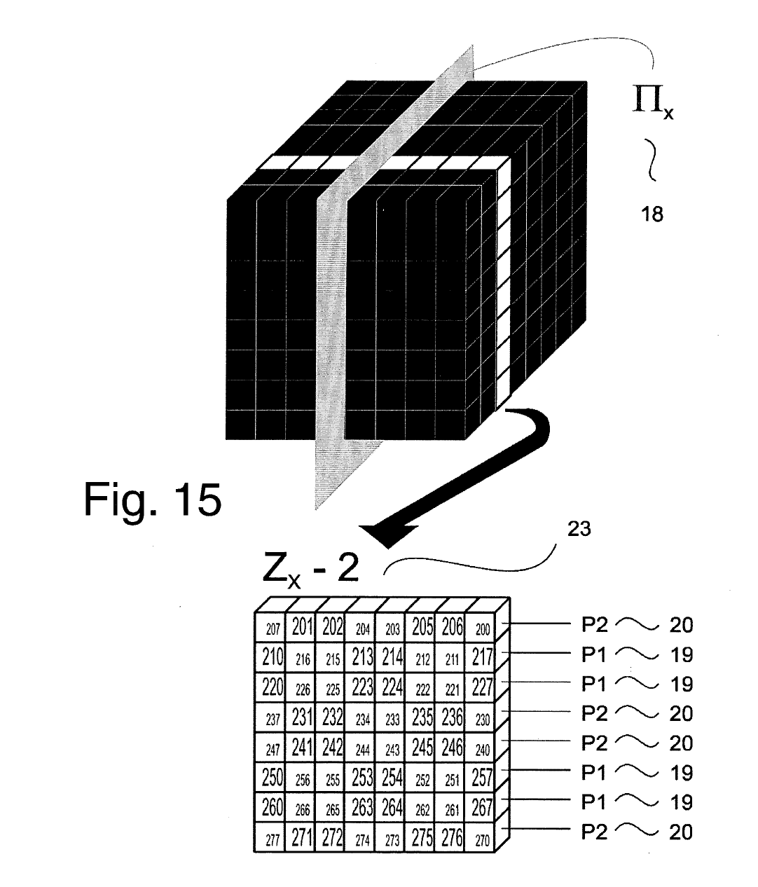

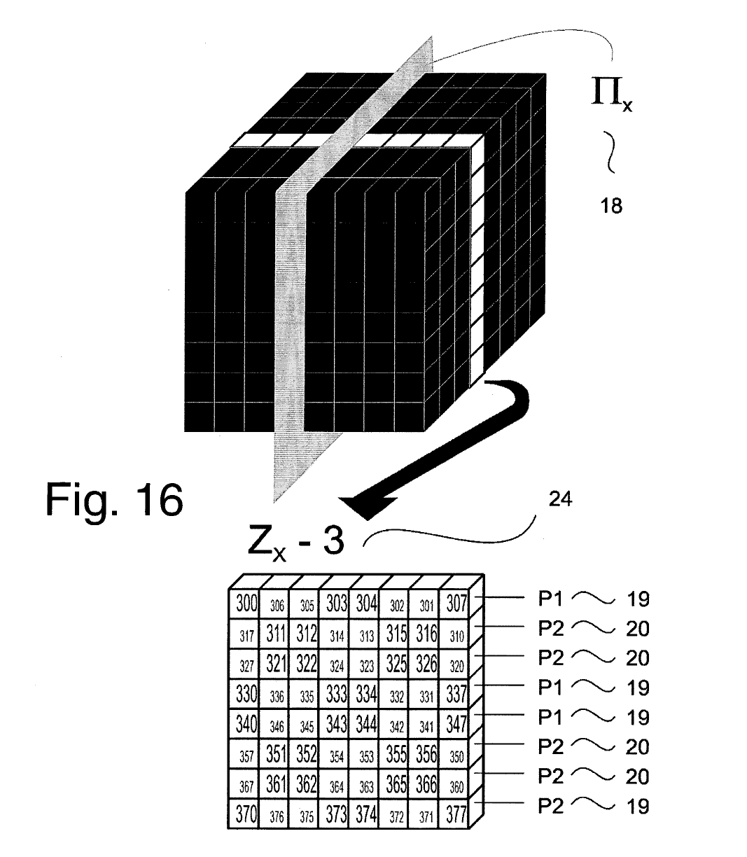

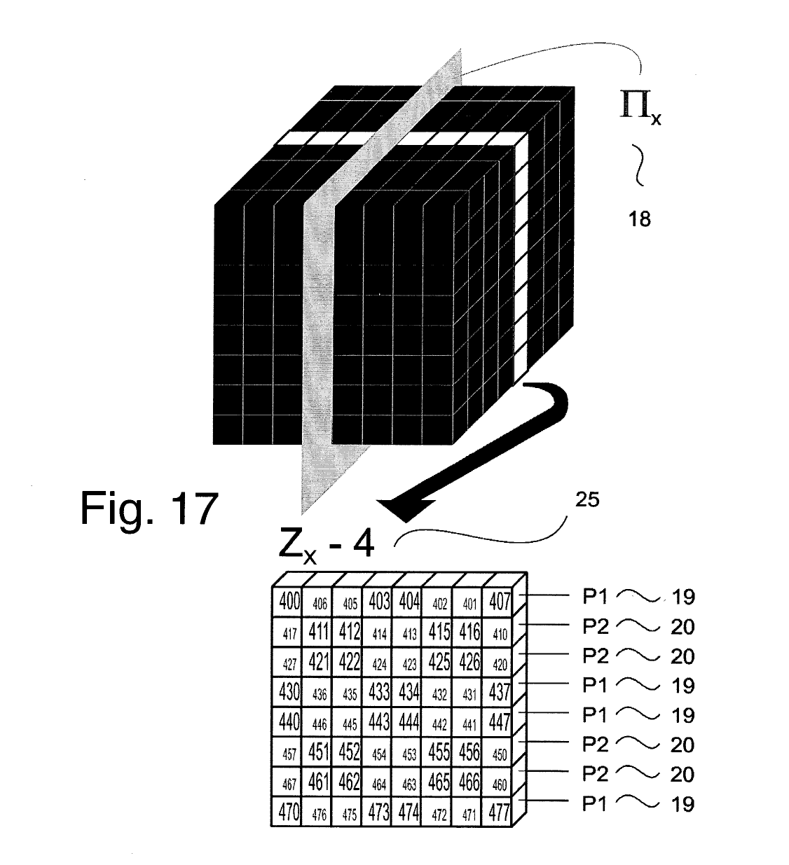

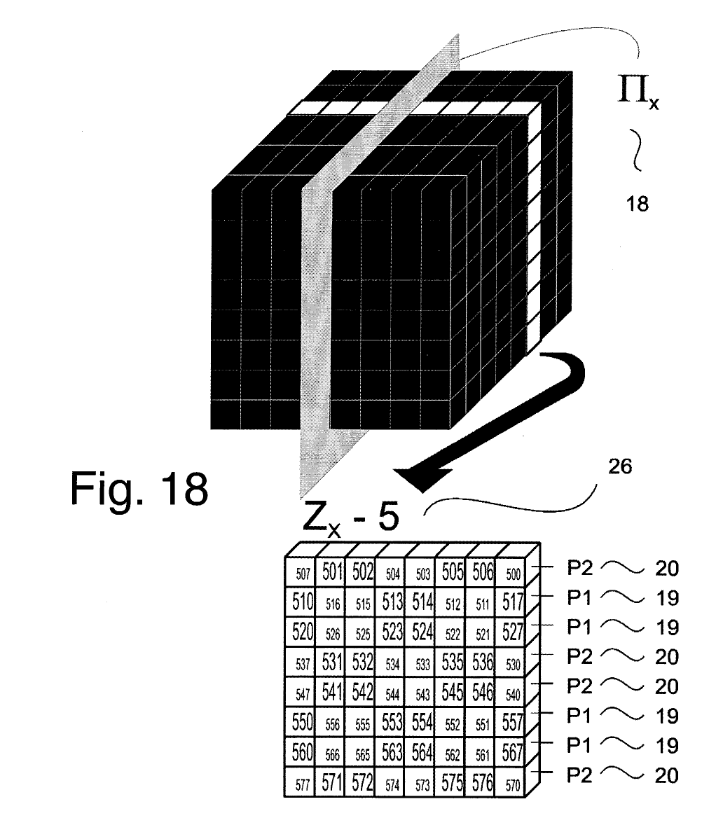

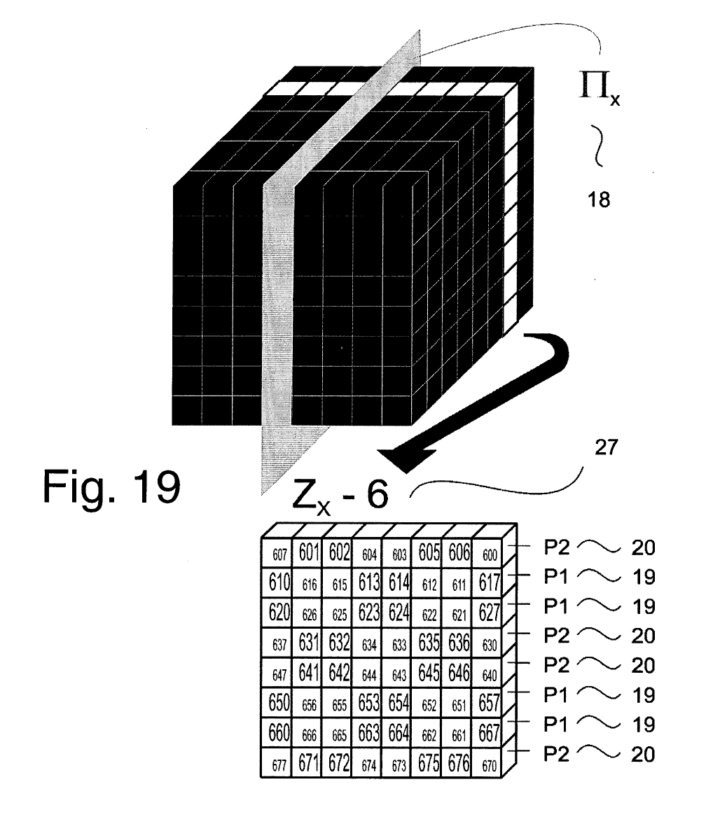

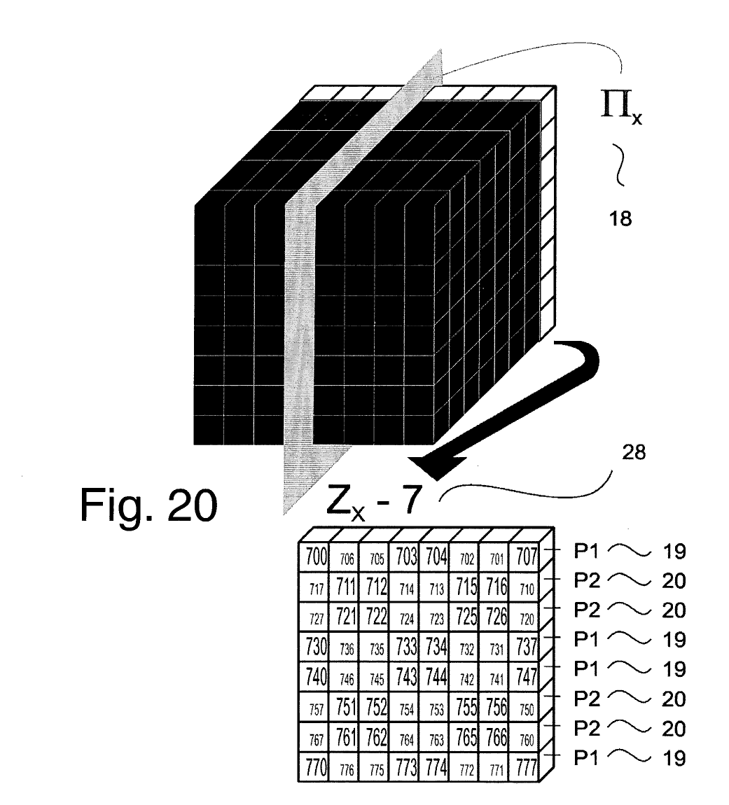

FIGS. 13 to 20 show the result of a reflection on the middle plane of X coordinate (4). (Symmetry plane on Π_{X} (18) coordinate.)

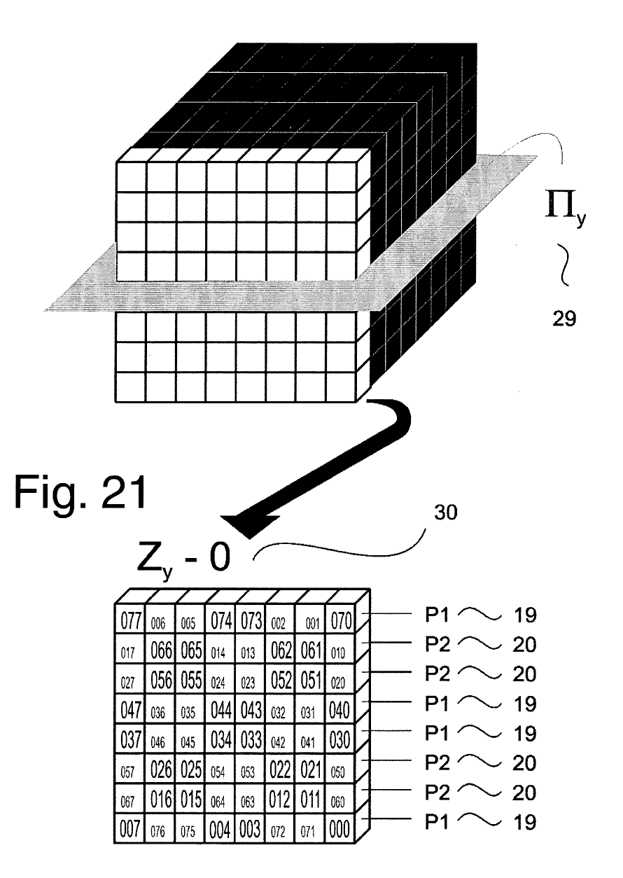

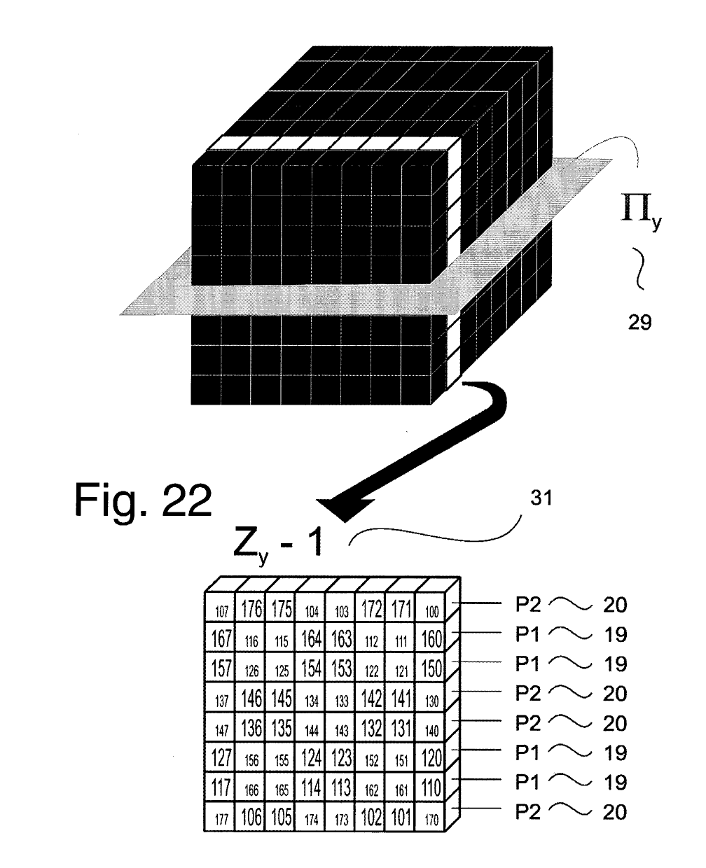

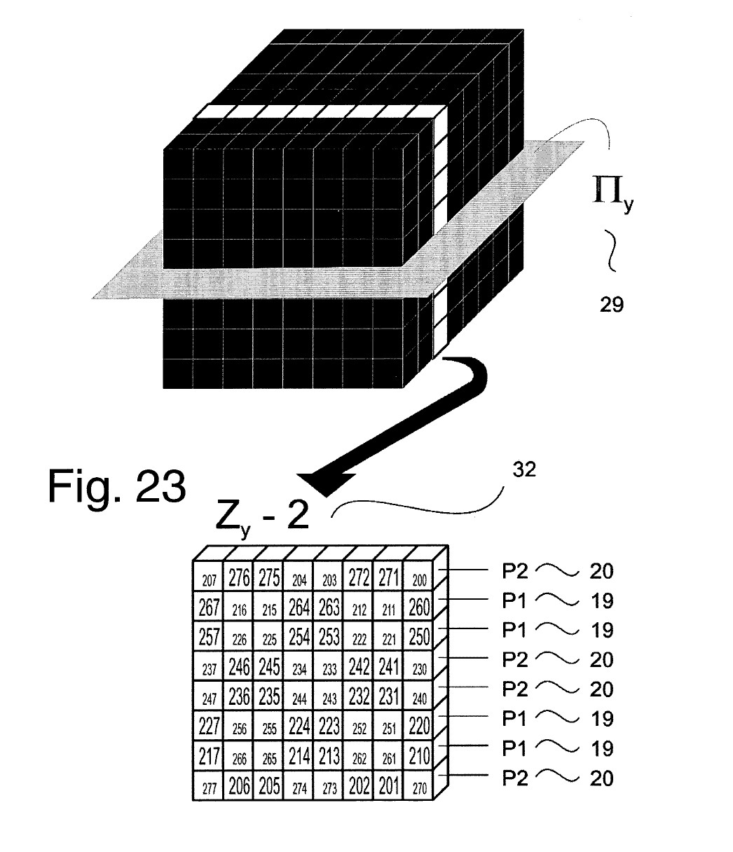

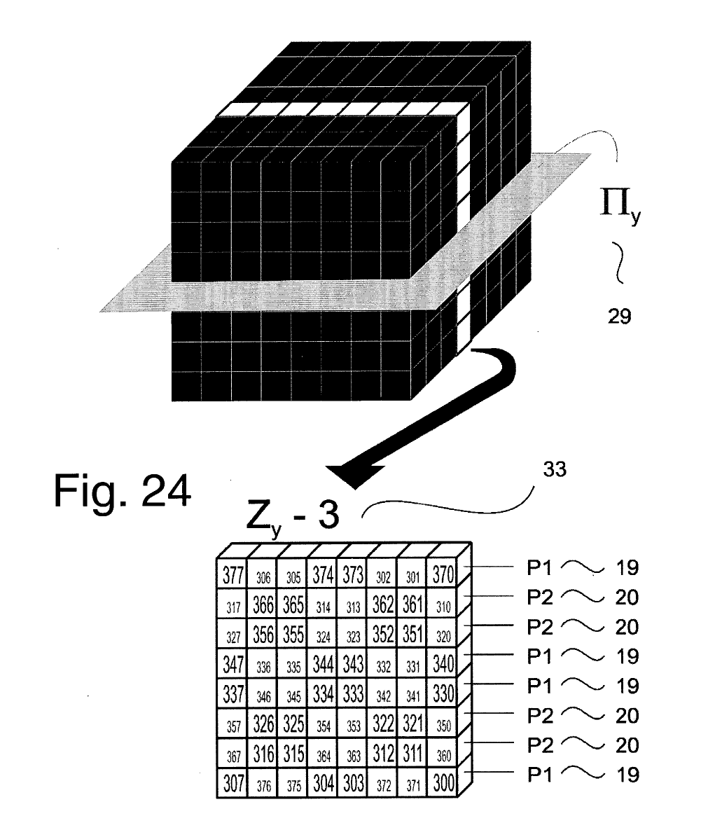

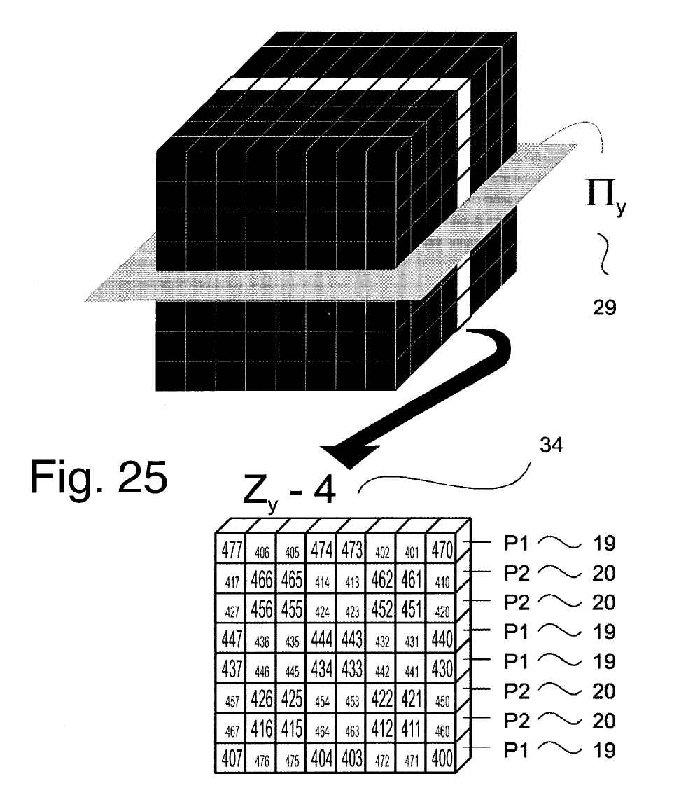

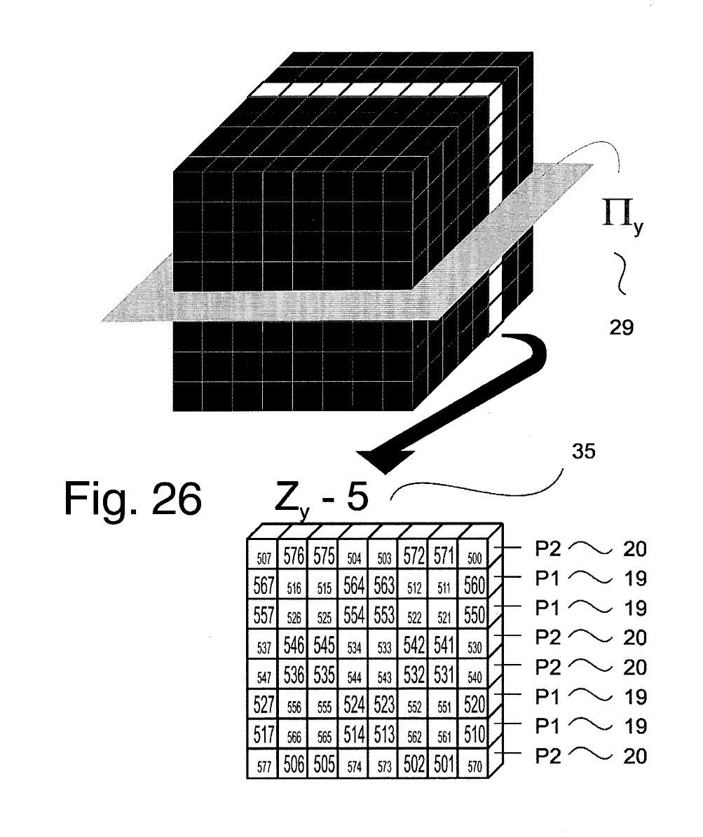

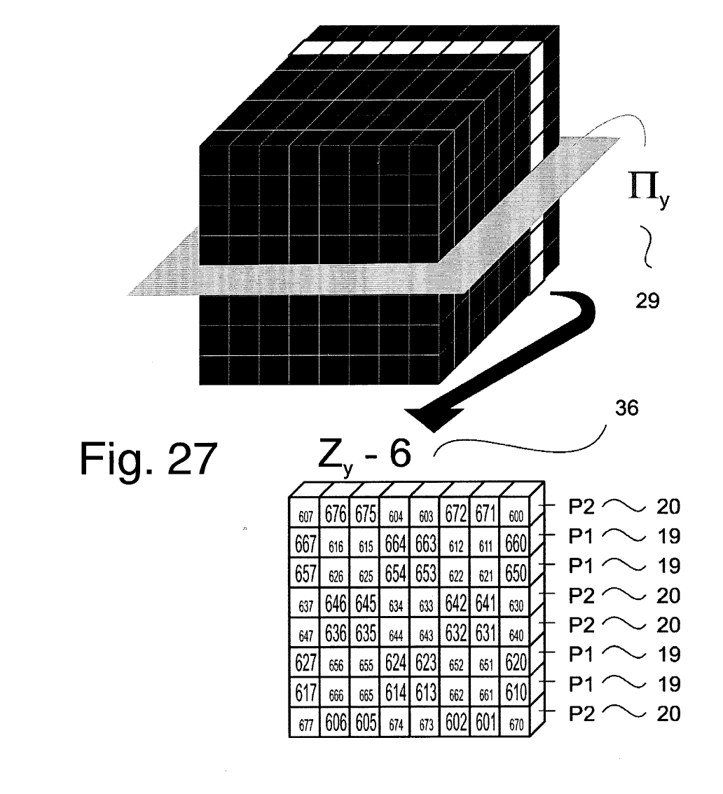

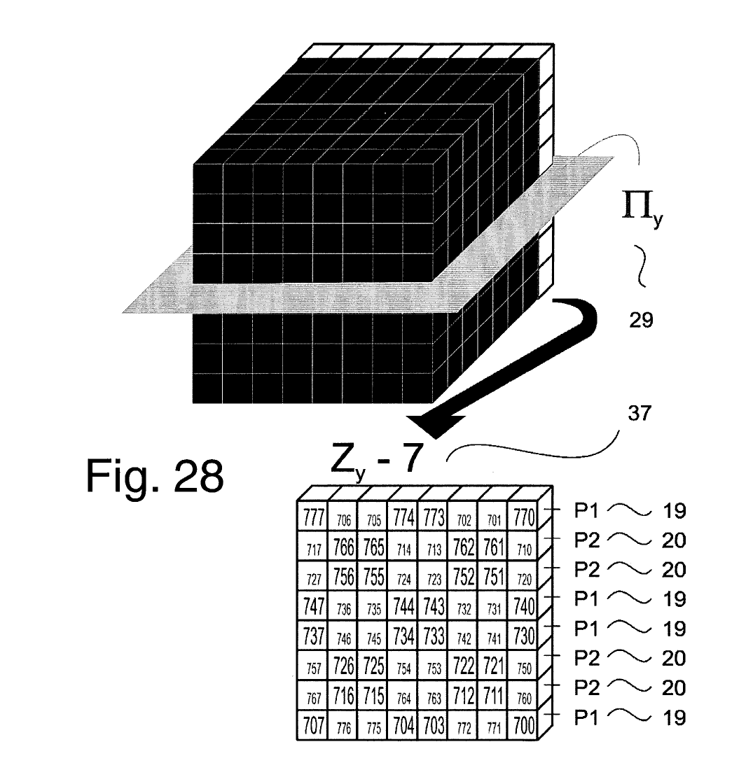

FIGS. 21 to 28 show the result of a reflection on the middle plane of Y coordinate (3). (Symmetry plane on Π_{Y} (29) coordinate.)

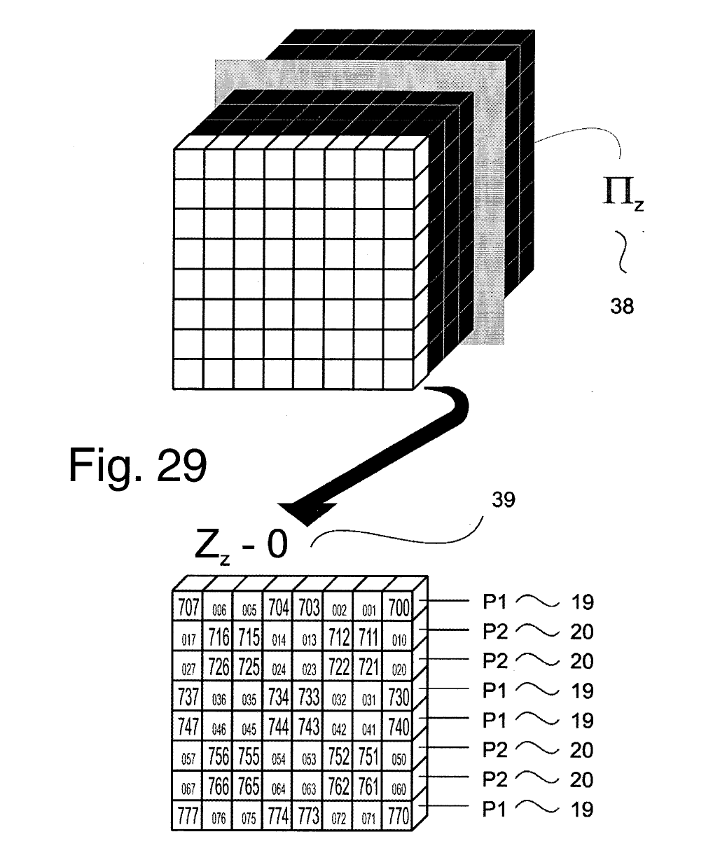

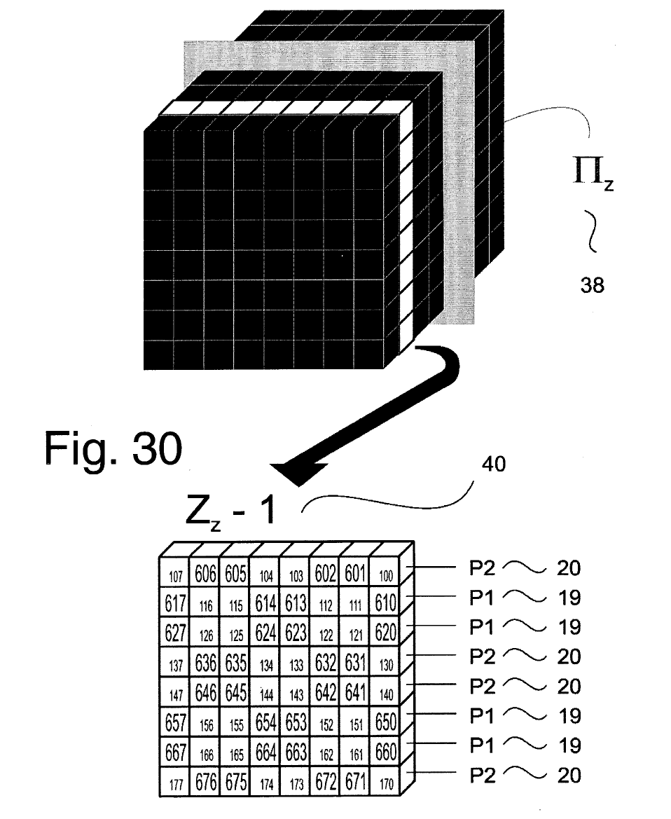

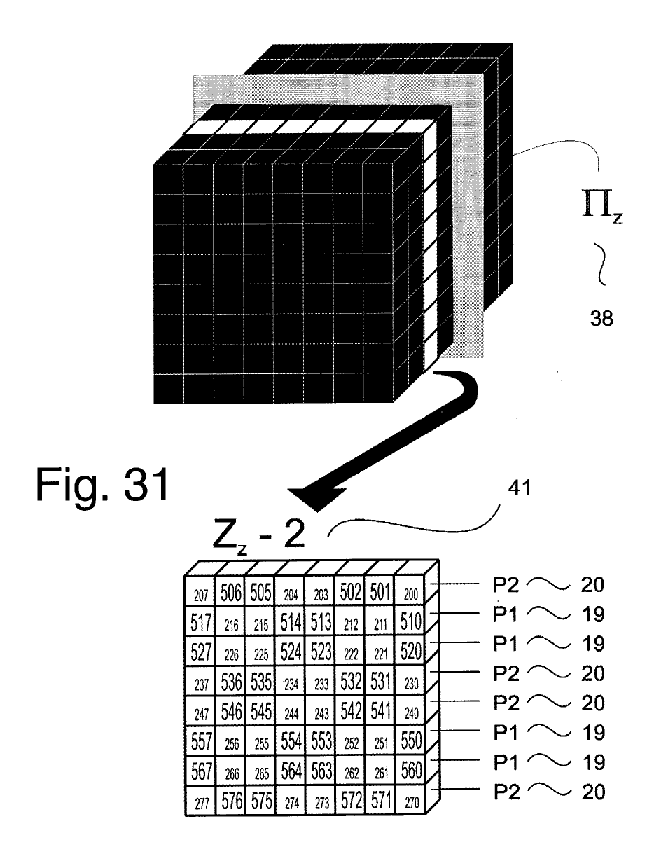

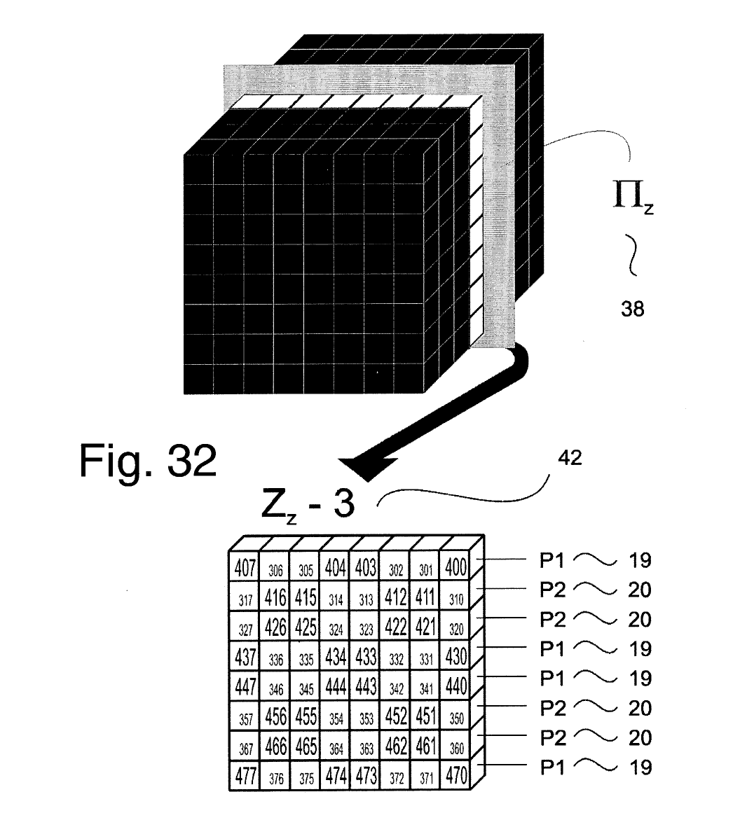

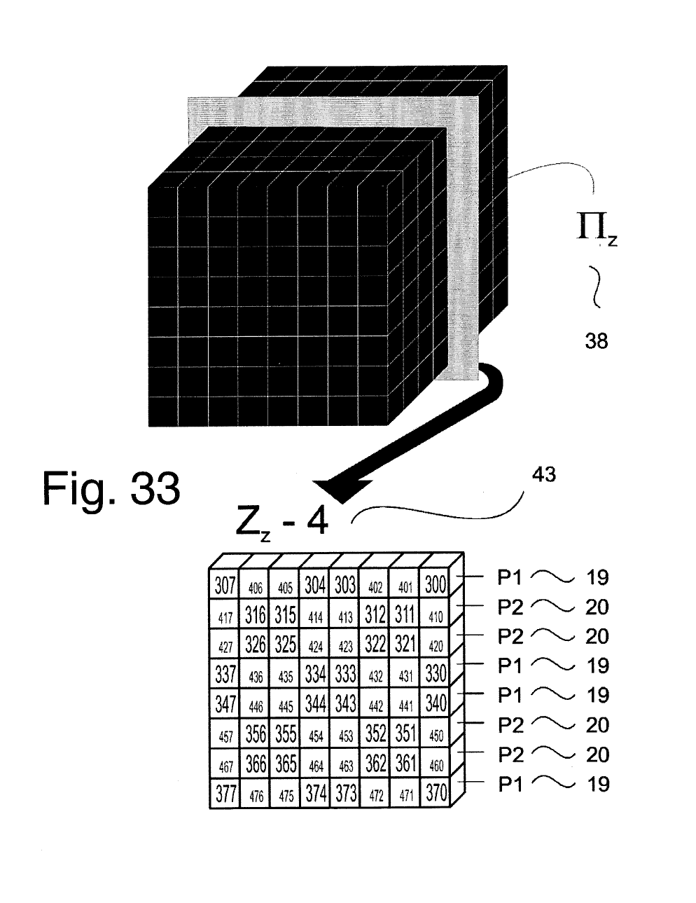

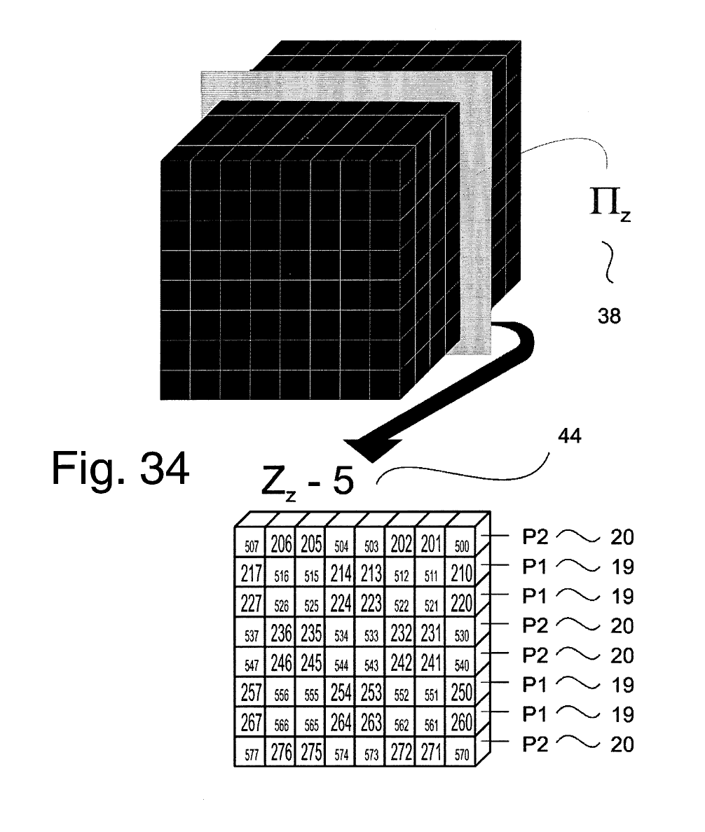

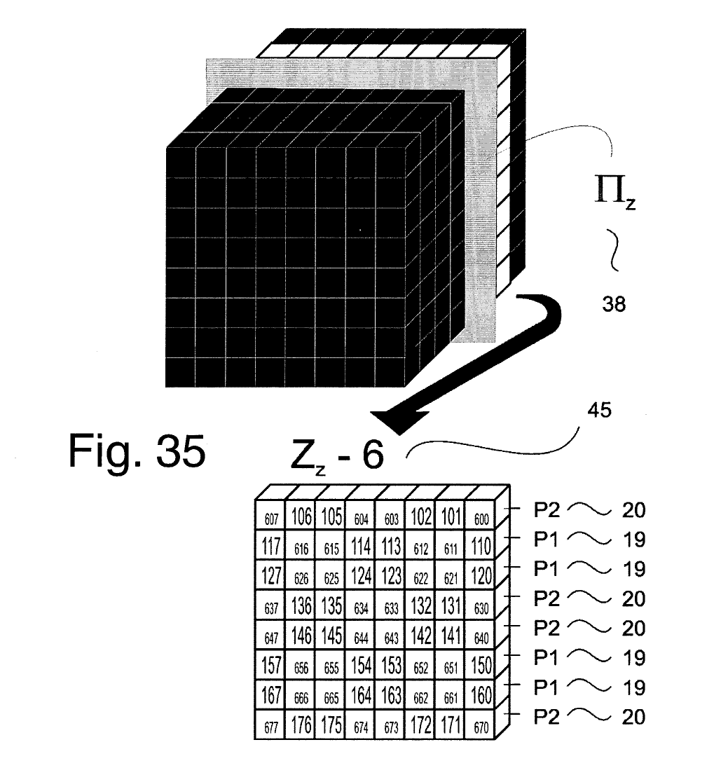

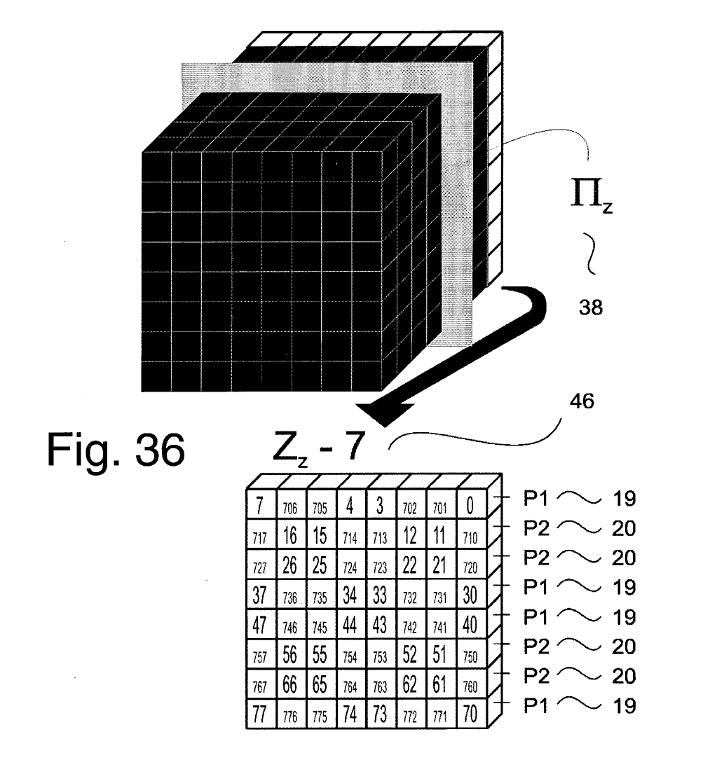

FIGS. 29 to 36 show the result of a reflection on the middle plane of Z coordinate (2). (Symmetry plane on Π_{Z} (38) coordinate.)

In FIGS. 13 to 36 you can see the variation—stay patterns, P1 (19), P2 (20),—of the sub-units or cells related to the initial ordering (1). To be more precise, we will see Z_{X}-0 layer(21) on FIG. 13, corresponding to the result of a reflection on Π_{X} symmetry plane, going through the middle point of X coordinates axis (4).

In order to describe previous result, if we begin on position 000 (5) of the initial ordering of the first row of Z_{X}-0 (21), we can see that there has been a change on 007 value; that sub-units or cells 001 and 002 have not changed, as it happens for 005 y 006; that cells 003 and 004 exchanged their values; and that the value of the 007 cell in the initial ordering is now 000. The transformation that generates the new ordering by acting on the top row is called P1 pattern (19). Strictly speaking, P1 is a permutation of the first eight cells or sub-units of the first row of z-0 layer (21).

Continuing with the description of the following row, we can appreciate that the variation (19)-stay (29) pattern changes; cell 010 stays, and the pair 011-012 on the initial ordering is replaced by pair 016-015 respectively, as a result of the reflection. Pair 013-014 on the initial ordering stays, as well as cell 017. The transformation that generates the new ordering by acting on the initial ordering (1) is called P2 pattern (20). P2 pattern (20) is another permutation, defined in the same way as P1.

There are no more new patterns in the rows of the layer, but there is a pattern sequence that has a pattern itself. As previous definitions show, the pattern sequence's pattern in Z_{X}-0 layer (21) is (only rows are taken into account):

P1, P2, P2, P1, P1, P2, P2, P1.

This way, we can describe Z_{X}-0 (21) layer with this list:

{P1, P2, P2, P1, P1, P2, P2, P1}.

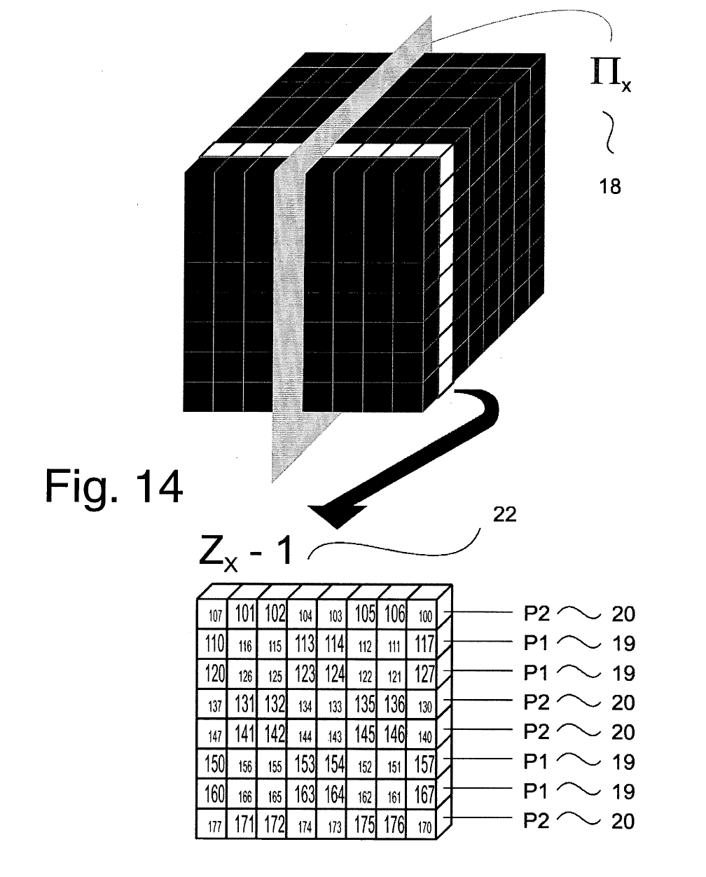

Continuing the description with next Z_{X}-1 layer (22) (FIG. 14), using the same method -rows- as in previous layer, patterns P1 (19) and P2 (20) are the only patterns that appear, but in a different sequence. This can be described using the following list:

{P2, P1, P1, P2, P2, P1, P1, P2}.

In a general way, the structure of the cube resulting from the reflection can be described as a whole, using a list of lists, in the following way:

Cubeᵣₑₛ={Π₁, Π₂, Π₂, Π₁, Π₁, Π₂, Π₂, Π₁}

where:

Π₁={P1, P2, P2, P1, P1, P2, P2, P1}

Π₂={P2, P1, P1, P2, P2, P1, P1, P2}

The rest of the reflections can be described in a similar way using symmetry planes Π_{Y}, Π_{Z}.

The symmetry operations set applied on the varying sub-units or cells can be any of those defining the holohedrism of the cubic system. Therefore, these operations can preferably be:

Three consecutive reflections in relation to the three symmetry planes of the cube, all of which are orthogonal to its faces.

Three successive turns in the same direction, each one in relation to one of the three symmetry binary axes of the cube 3E⁴.

Four successive turns in the same direction, each one in relation to one of the four symmetry ternary axes of the cube 4E⁴.

Six successive turns in the same direction, each one in relation to one of the six symmetry binary axes of the cube 6E⁴.

An inversion in relation to the symmetry centre of the cube.

This result does not depend on the origin of coordinates 000 (5), that is to say wherever it is.

Preferably through these or other equivalent operations, we establish a non-linear (non-consecutive) ordering from the initial basic structure (1), obtaining as a result the unit pattern structure (49).

The fractal and recurring behavior of the unit pattern structure (49) let us obtain every reference's position (defined by the three digits groups from 000 to 777) from its geometrical position. This is made possible by the relationships set that allows the positioning of the blocks formed by 2, 4, 8, 16, 32, 64, 128, or 256 sub-units or cells in a way that we can simultaneously operate all the 512 sub-units or cells.

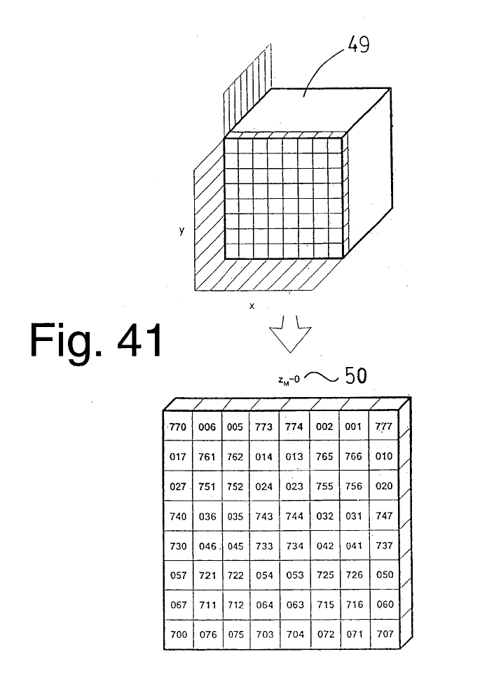

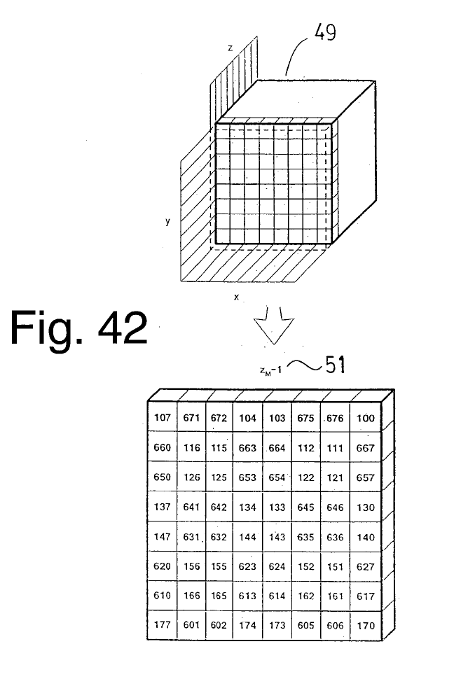

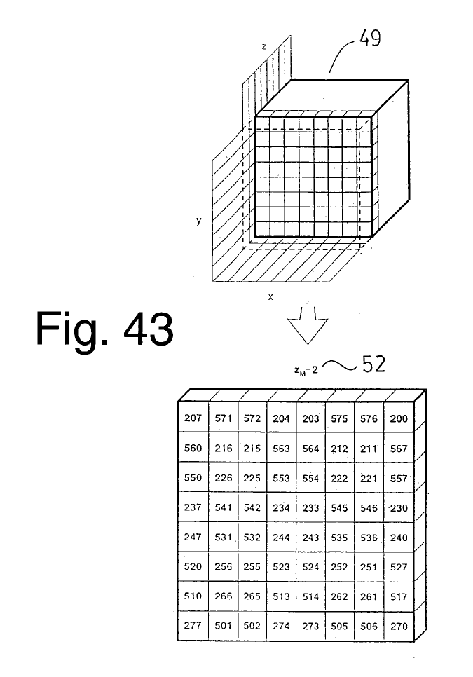

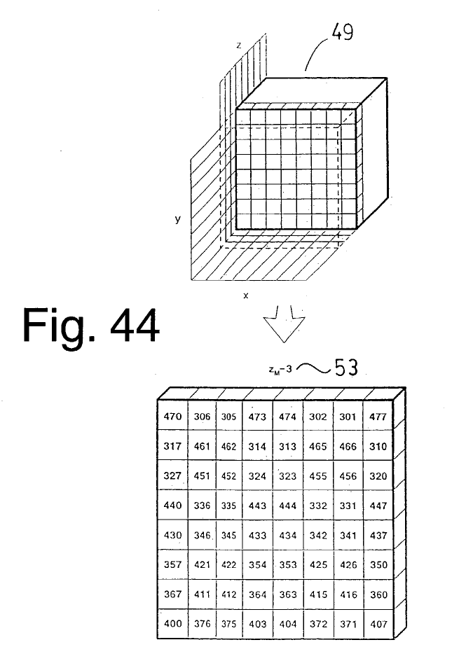

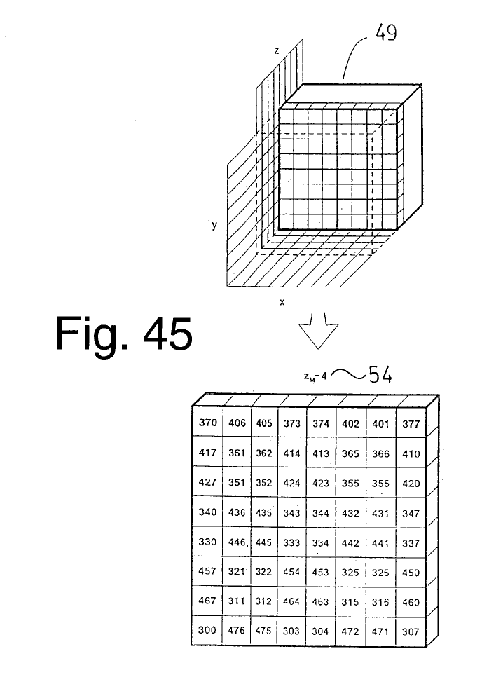

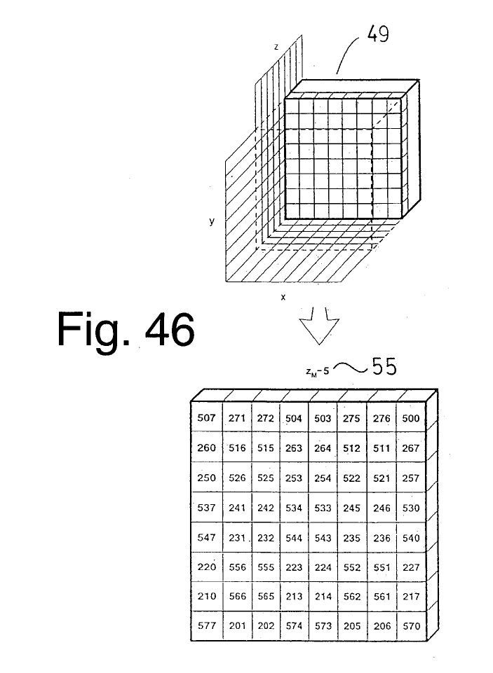

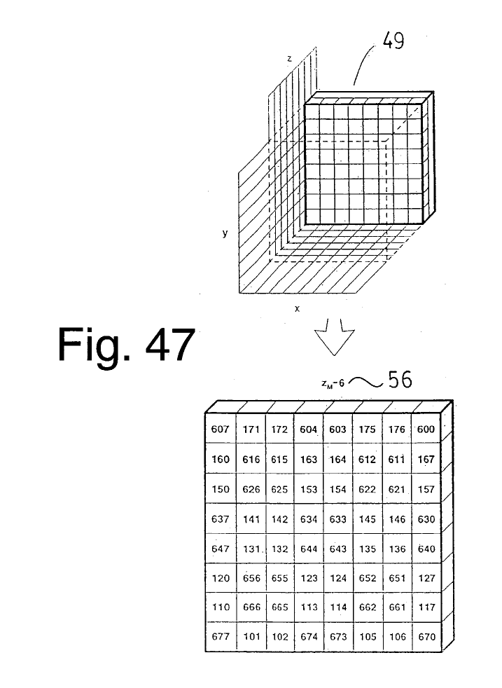

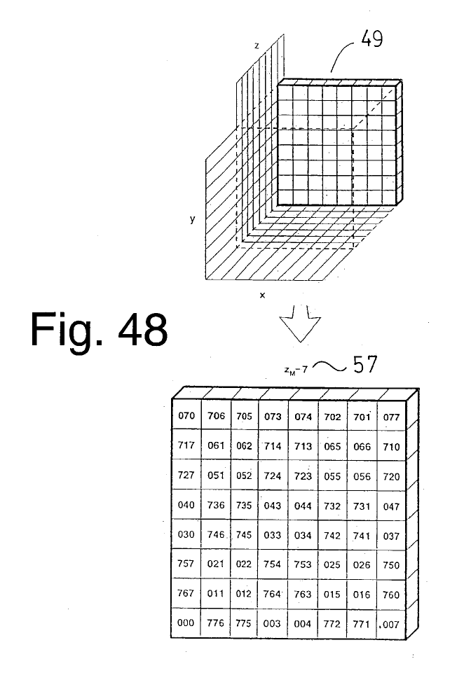

In FIGS. 41 to 48 (49) we can see the variation/stay patterns of the sub-units or cells related to the initial ordering (1). To be more precise, we will comment the relationship between Z_{M}-0 layer (50) in FIG. 41, and Z_{M}-7 layer (57) on FIG. 48.

Starting from position 000 (5) in the initial ordering (1); in the first row of Z_{M}-0 (50) we can see now the value 777 (9), coming from the initial (1) 777 position (9). Initial positions 001 and 002 on the first row of Z_{M}-0 (50) don't change, but in initial positions 003 and 004 we have now the values 774 and 773 respectively. Next initial positions, 005 and 006, do not change either. In addition, the value of initial position 007 is now 770.

When the description continues with the row below and the row above the previous rows, respectively, we can see that the variation/stay pattern changes; cells 010 and 760 stay; and, because of the inversion in relation to the symmetry centre, pair 011-012 in initial ordering (1) is substituted by the pair formed with 766 and 765, respectively. Pair 013-014 in initial ordering (1) does not change, and the same happens for pair 763-764. Cells 015 and 016 from initial ordering (1) now have the values 762 and 761, respectively. Finally, cells 017 and 767 do not change.

There are no new patterns. The relationship between the third row in Z_{M}-0 layer (50), and the third row from the end in Z_{M}-7 (57) follows the pattern described in the previous paragraph, while the fourth pair follows the pattern defined by the relationship between the first row in Z_{M}-0 (50) layer, and the first row from the end in Z_{M}-7 (57) layer. The other four pairs repeat the previously described pattern.

The transformation that generates the new ordering by acting on the initial ordering (1) of this two layers is designated as P′1 pattern.

If we compare the figures for Z_{M}-6 (56) and Z_{M}-1 (51) layers and follow a similar procedure we are able to define P′2 transformation.

This way, the complete pattern structure could be described using the following list:

{P′1, P′2, P′2, P′1}.

If we define a fourth coordinate, W (58), we can add the fractal character to the structure. This way, this structure can be perfectly defined with the following list:

Cube_{fract}={Π′₁, Π′₂, Π′₂, Π′₁, Π′₁,Π′₂, Π′₂, Π′₁}

where:

Π′₁={P′1, P′2, P′2, P′1}

Π′₂={P′2, P′1, P′1, P′2}

This fourth coordinate, with the same characteristics as the previous ones, allows us to define 8 consecutive fractality levels in each of the 512 sub-units defined in the unit structure.

The unit structure's fractal property or characteristic does not change as long as the motion through the successive levels of the structure is horizontal, which means that the successive route is: 512 elements or sub-units in the first level, 512² elements in the second level, 512³ elements in the third level and so on until the eighth level that will contain 512⁸ elements. To pass from the last element of a certain level -X- (subunit 777^{x} in base 8) to the first one of the next level (subunit 000^{x+1}) the patterns sequence previously described is used.

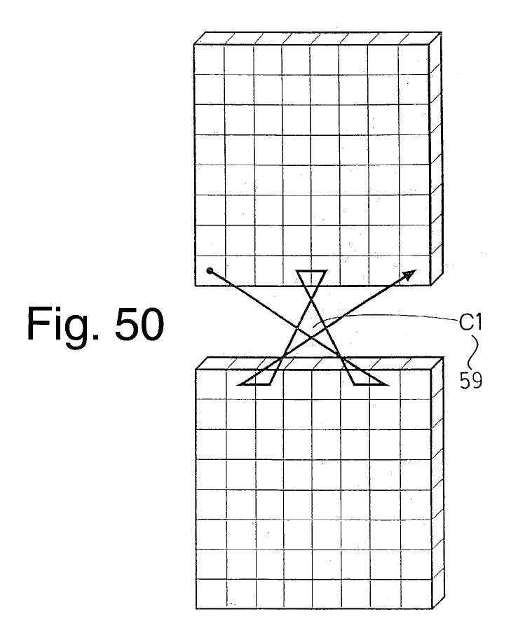

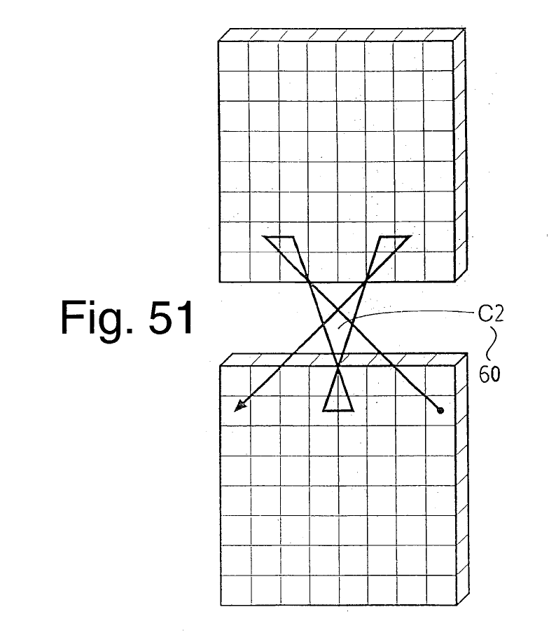

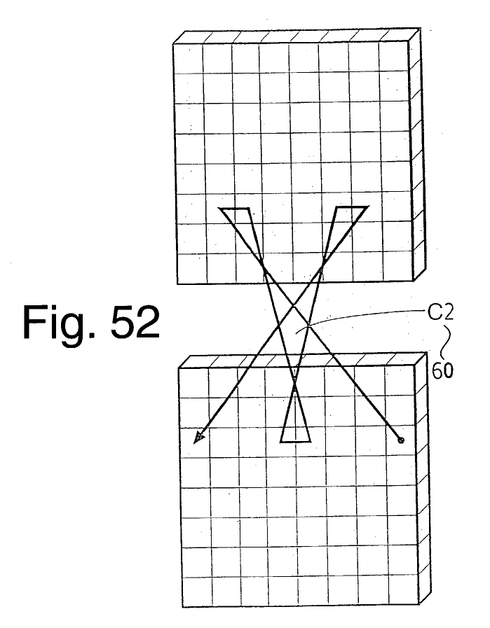

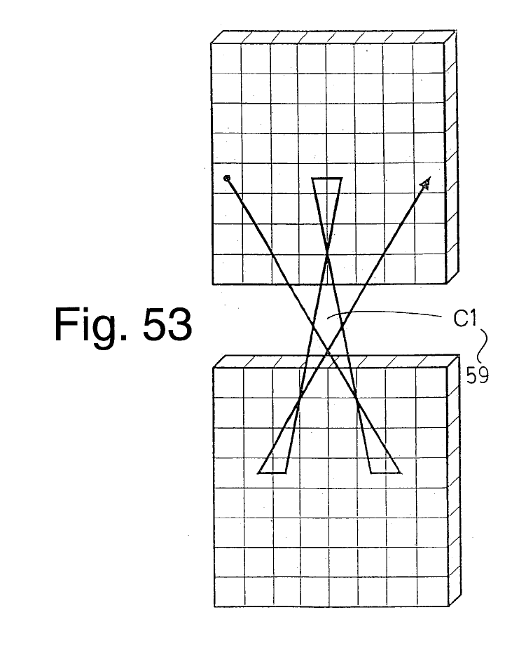

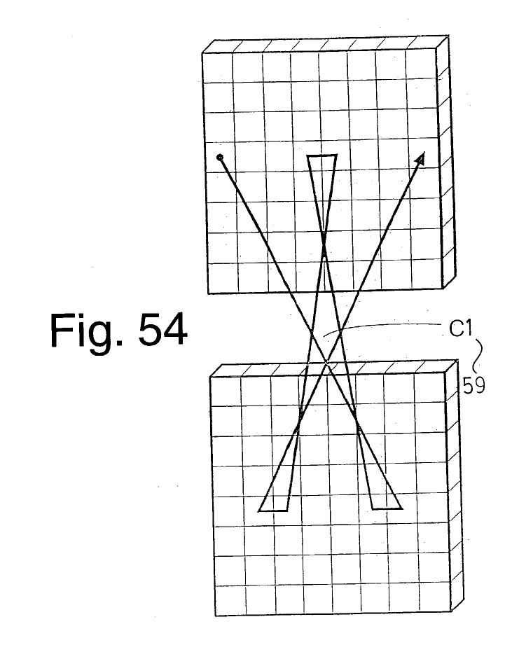

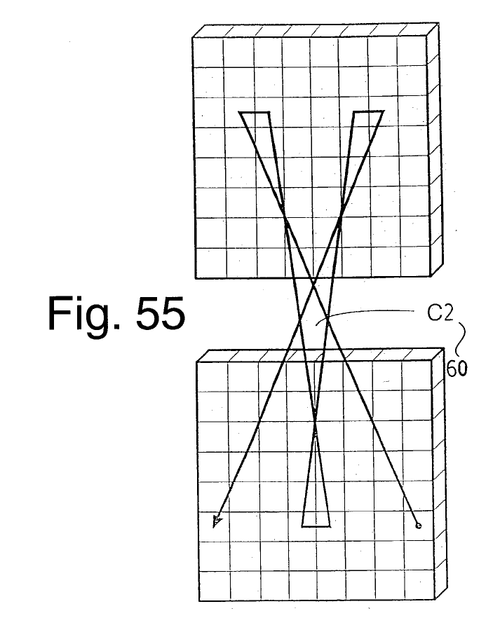

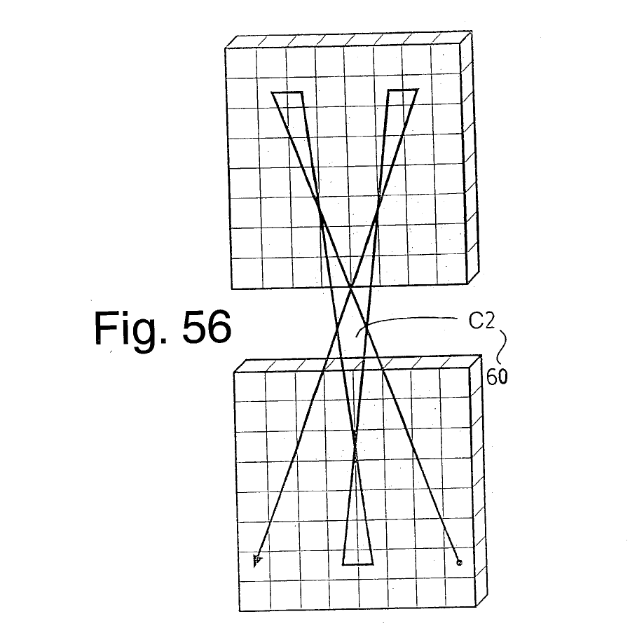

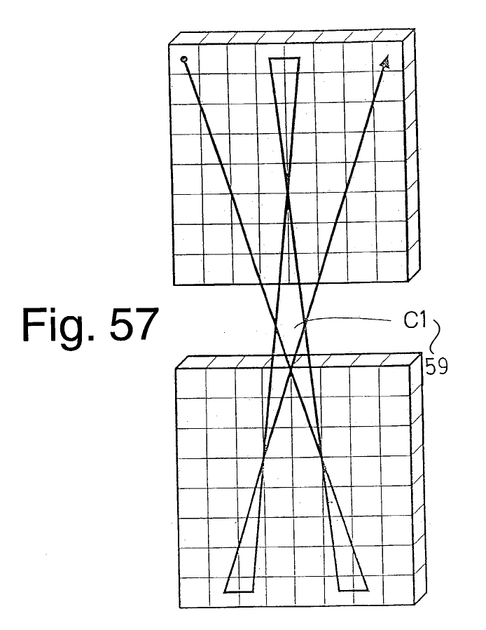

The graphs in FIGS. 50 to 57 represent stages, and together show a pattern in graphs' sequence. With the exception of some kind of similarity, the graphs of the figures can be separated into class C1 (59) and class C2 (60), and based on this the regularity pattern can be described as follows: C1, C2, C2, C1, C1, C2, C2, C1.

Continuing with this description, the next sequence of eight graphs would render the following regularity: C2, C1, C1, C2, C2, C1, C1, C2. The previously described path is a 64 stages cycle (closed path).

In short, it is an information processing system that, based on a three-dimensional non-linear (non-consecutive) numerical ordering of the information points, establishes within a discrete structure or matrix, that we will define as pattern unit, a series of relationships between the information points contained in it, in such a way that it allows us to operate on all of them simultaneously.

Considering the applications scope, the result produced by the inversion regarding the center of the cube, considering all the levels, generates a new (non-sequential and non-random) order, for the stack of memory.

The 256th factorial possible permutations of the cells which vary in the first cube, are considered as simple geometric transformations.

It is provided that the transformation who rules the permutations of the three-dimensional non-linear numerical ordering system, might be expressed on the basis of group theory; for instance, if we use i=1, i=2, i=3, . . . i=8, we can span starting from scalars to reach the basic dimension of this system, which is really 8th, because the following properties are maintained. The positions are independent. All the space is spanned with the set of cube transpositions which can be achieved by the Lie group theory in which the crystallographic transformations are considered.

The applications of the three-dimensional non-linear numerical ordering system scope range over data base management, memory management, advanced compiler algorithms and distributed memory machines.

Being found that the involved transformation for i=3, considering the previous mentioned properties, 3-D cube optimization is allowed, being possible to extend this property up to i=8 dimension.

The application of the three-dimensional non-linear numerical ordering system must be handled on distributed memory machines, given that these machines are more extended and include the previous ones. So, currently we have computers, going from private memory to shared memory, considering processes which can go from implicit to explicit.

The compilers usually consider pointers to define memory positions; so our cube system can assign these positions and many others, using powerful algorithms, which are involved in the Lie group structure.

The processes in distributed memory computers are parallel processes, which means that each array vector can be assigned to a vector of the cube system, which are independent and almost infinite, being this the basis required by parallel computers.

The access to memory is also improved by the same reason, given that assigning the array vectors of the system to memory stack is easy, neither requiring a large capacity nor sophisticated algorithms.

Private memory computers are based on message passing interface; using the three-dimensional non-linear numerical ordering system the algorithms—for this kind of machines, we can assign the value of these messages (arrays) to three-dimensional non-linear numerical ordering system vectors.

Using the same mentioned procedure, the accessing velocity is improved, being this the case of shared memory computers.

It optimizes computing systems by reducing the number of digits required to identify and operate with information volumes, being able to represent hierarchically the connections that can be established between the information volumes considered in the sub-units or cells, and the number of possible sub-units or cells integrated in the system being in the order of 512^{8.} The system can manage conceptual information bases with a capacity and definition level extraordinarily superior to the current ones.

Applications that are more specific include, amongst others hardware, such as Computer hard drive organizing system, Computer memory managing system, Information compressing device that can be used when storing or transferring information, Encoding and encrypting device that can be used when transferring digital information, and software, such as Multimedia information manager in fields such as multimedia information base management or multiple signal control via satellite, Searcher in interconnected networks, Three-dimensional classification and representation system, Electronic equipment control system, Alert systems (medical, etc.), Message connection, encoding, and exchange in electronic communications equipment (management protocols, etc.), Conceptual (knowledge oriented) information base manager, as a new information organization method, Management and artificial intelligence applications, such as, Tool for ordering the genome, and its evolution based on the minimal significant elements (acids) and Tool for controlling nuclear power stations and radioactive waste treatment.

Now that the nature of this invention has been sufficiently described, it only remains to be said that variations are possible either in the system as a whole or in any of its parts, for example, changing from a basic cube with 16, 32, 64, etc., segments in each coordinate, without changing the nature of the invention claimed hereunder.

While a specific embodiment of the invention has been shown and described in detail to illustrate the application of the principles of the invention, it will be understood that the invention may be embodied otherwise without departing from such principles.

What is claimed is:

1. A three-dimensional non-linear or non-consecutive numerical ordering system (49), designed to be used on computing media for information handling, and with a starting structure comprising:
a system that contains eight levels formed by fitting cubes (58), the first level consisting of a cube divided into cells, where each of its three axes is divided into eight segments numbered, optionally from 0 to 7, in base 8 from the origin of coordinates 000 (5);
wherein the initial structure is divided into 512 equal sub-units or cells, defined by three digits, each one of them being the segment of the coordinate that represents its location in relation to the axes z (2), y (3), x (4) respectively, in such a way that the subunit or cell that represents the origin point of coordinates will be identified by the digits 000 (5), and the adjacent sub-units or cells will be defined by the digits 100 (6), 010 (7) and 001 (8) (corresponding to each axis) and so on, until the 8³ sub-units or cells are completed;
the last subunit, number 512, always following in base 8, will be defined by the digits 777 (9), and will be located at the end opposite to the first one, following the main diagonal of the cube, identified by the digits 000 (5), in relation to the symmetry centre; and
every cell consists of a fitting structure with seven cubes (58).

2. Three-dimensional non-linear or non-consecutive numerical ordering system (49) according to claim 1, resulting from a reflection operation on the symmetry plane that crosses through the middle point of X axis (Π_{X}), that could be described from
Cubeᵣₑₛ={Π₁, Π₂, Π₂, Π₁, Π₁, Π₂, Π₂, Π₁}
wherein:
Π1={P1, P2, P2, P1, P1, P2, P2, P1}
Π2={P2, P1, P1, P2, P2, P1, P1, P2}; and
wherein the two remaining reflections can be described in a similar way using symmetry planes Π_{Y}, Π_{Z}.

3. Three-dimensional non-linear numerical ordering system (49) as described in claim 1, characterized by the set of symmetry operations defining the holohedrism of the cubic system, including:
Three consecutive reflections in relation to the three symmetry planes of the cube, all of which are orthogonal to its faces.
Three successive turns in the same direction, each one in relation to one of the three symmetry binary axes of the cube (3E⁴).
Four successive turns in the same direction, each one in relation to one of the four symmetry ternary axes of the cube (4E⁴).
Six successive turns in the same direction, each one in relation to one of the six symmetry binary axes of the cube (6E⁴).
An inversion in relation to the symmetry centre of the cube (C).

4. Three-dimensional non-linear numerical ordering system (49) as described in claim 2, characterized by the set of symmetry operations defining the holohedrism of the cubic system, including:
Three consecutive reflections in relation to the three symmetry planes of the cube, all of which are orthogonal to its faces.
Three successive turns in the same direction, each one in relation to one of the three symmetry binary axes of the cube (3E⁴).
Four successive turns in the same direction, each one in relation to one of the four symmetry ternary axes of the cube (4E⁴).
Six successive turns in the same direction, each one in relation to one of the six symmetry binary axes of the cube (6E⁴).
An inversion in relation to the symmetry centre of the cube (C).

5. Three-dimensional non-linear or non-consecutive numerical ordering system (49) as described in claim 1, resulting from an inversion transformation based on the symmetry centre of the cube, which could be described using the following list of lists:
Cube_{fract}={Π′₁, Π′₂, Π′₂, Π′₁, Π′₁, Π′₂, Π′₂, Π′₁}
where:
Π′1={P′1, P′2, P′2, P′1}
Π′2={P′2, P′1, P′1, P′2}
wherein it can be deduced that the behavior on the fourth coordinate, W (58), is the same as in the other three coordinates, Z (2), Y (3), X (4).

6. Three-dimensional non-linear or non-consecutive numerical ordering system (49) as described in claim 2, resulting from an inversion transformation based on the symmetry centre of the cube, which could be described using the following list of lists:
Cube_{fract}={Π′₁, Π′₂, Π′₂, Π′₁, Π′₁, Π′₂, Π′₂, Π′₁}
where:
Π′1={P′1, P′2, P′2, P′1}
Π′2={P′2, P′1, P′1, P′2}
wherein it can be deduced that the behavior on the fourth coordinate, W (58), is the same as in the other three coordinates, Z (2), Y (3), X (4).

7. A three-dimensional non-linear or non-consecutive numerical ordering system (49) as described in claim 1, characterized in that the fractal behavior allows one to establish relationships for every 2, 4, 8, 16, 32, 64, 128, or 256 sub-units or cells, in a way that can be used to define the 512 sub-units or cells in the first level, and, combined with the W coordinate (58), also the whole unit pattern structure just knowing the position of one of them, allowing one to operate in a non-linear or non-sequential way; and thus the three-dimensional non-linear or non-consecutive numerical ordering system (49) can use extensions for dimensions that are considered as values in Z (2), Y (3), X (4) and W (58) coordinates.

8. A three-dimensional non-linear or non-consecutive numerical ordering system (49) as described in claim 2, characterized in that the fractal behavior allows one to establish relationships for every 2, 4, 8, 16, 32, 64, 128, or 256 sub-units or cells, in a way that can be used to define the 512 sub-units or cells in the first level, and, combined with the W coordinate (58), also the whole unit pattern structure just knowing the position of one of them, allowing one to operate in a non-linear or non-sequential way; and thus the numerical ordering system (49) can use extensions for dimensions that are considered as values in Z (2), Y (3), X (4) and W (58) coordinates.

9. A three-dimensional non-linear or non-consecutive numerical ordering system as described in claim 1, characterized in that the unit pattern structure's (15) fractal characteristic or property does not change as long as the motion through the successive levels of the structure is horizontal, which means that the successive route is 512 sub-units or cells in the first level, 512² sub-units or cells in the second level, 512³ sub-units or cells in the third level, 512⁴ sub-units or cells in the fourth level, 512⁵ sub-units or cells in the fifth level, 512⁶ sub-units or cells in the sixth level, 512⁷ sub-units or cells in the seventh level, 512⁸ sub-units or cells in the eighth level.

10. A three-dimensional non-linear or non-consecutive numerical ordering system as described in claim 2, characterized in that the unit pattern structure's (15) fractal characteristic or property does not change as long as the motion through the successive levels of the structure is horizontal, which means that the successive route is 512 sub-units or cells in the first level, 512² sub-units or cells in the second level, 512³ sub-units or cells in the third level, 512⁴ sub-units or cells in the fourth level, 512⁵ sub-units or cells in the fifth level, 512⁶ sub-units or cells in the sixth level, 512⁷ sub-units or cells in the seventh level, 512⁸
